(19) United States
(12) Patent Application Publication
(10) Pub. No.: US 2025/0284294 A1
(43) Pub. Date: Sep. 11, 2025

(54) ELECTRONIC DEVICE AND METHOD FOR CONTROLLING PLATOONING VEHICLES

(71) Applicant: THINKWARE CORPORATION, Seongnam-si (KR)

(72) Inventor: Haejun JUNG, Seongnam-si (KR)

(21) Appl. No.: 19/069,762

(22) Filed: Mar. 4, 2025

(30) Foreign Application Priority Data
Mar. 5, 2024 (KR) 10-2024-0031638

(51) Int. Cl. G05D 1/69; G08G 1/00

(52) U.S. Cl. CPC G05D 1/69; G08G 1/22

(57) ABSTRACT

A device for platooning of vehicles includes memory storing instructions and a processor, and the instructions, when executed by the processor, causes the electronic device to identify branch points for each of the vehicles on a route of the platooning, identify distances from current positions of the vehicles to the branch points, determine an order of the vehicles in the platoon based on an ascending order of the identified distances, and based on determining that a lead vehicle in a current order of the vehicles in the platoon is different from a lead vehicle in the determined order and/or determining that a tail vehicle in the current order of the vehicles in the platoon is different from a tail vehicle in the determined order, control the vehicles such that the vehicles in the platoon are rearranged according to the determined order.

### CROSS-REFERENCE TO RELATED APPLICATION(S)

This application is based on and claims priority under 35 U.S.C. § 119 to Korean Patent Application No. 10-2024-0031638, filed on Mar. 5, 2024, in the Korean Intellectual Property Office, the disclosure of which is incorporated by reference herein in its entirety.

### BACKGROUND

### Technical Field

The present disclosure relates to an electronic device and a method for controlling platooning vehicles.

### Description of Related Art

Platooning is a technology that controls autonomous driving of two or more vehicles. Vehicles forming a platoon may drive while forming a certain formation. The platooning may, by reducing the spacing between the vehicles, improve fuel efficiency by reducing air resistance, reduce a risk of accidents, and reduce traffic congestion by controlling a vehicle flow. The vehicles forming the platoon may include a lead vehicle and following vehicles.

The above-described information may be provided as a related art for the purpose of helping to understand the present disclosure. No claim or determination is raised as to whether any of the above-described information may be applied as a prior art related to the present disclosure.

### SUMMARY

In an embodiment, an electronic device for platooning of vehicles may comprise memory storing instructions and a processor, and the instructions, when executed by the processor, may cause the electronic device to identify branch points for each of the vehicles on a route of the platooning, wherein the branch points are locations where the vehicles leave the platoon, identify distances from current positions of the vehicles to the branch points, determine an order of the vehicles in the platoon based on an ascending order of the identified distances, and based on determining that a lead vehicle in a current order of the vehicles in the platoon is different from a lead vehicle in the determined order and/or determining that a tail vehicle in the current order of the vehicles in the platoon is different from a tail vehicle in the determined order, control the vehicles such that the vehicles in the platoon are rearranged according to the determined order.

In an embodiment, a method performed by an electronic device for platooning of vehicles may comprise identifying branch points for each of the vehicles on a route of the platooning, wherein the branch points are locations where the vehicles leave the platoon, identifying distances from current positions of the vehicles to the branch points, determining an order of the vehicles in the platoon based on an ascending order of the identified distances, and based on determining that a lead vehicle in a current order of the vehicles in the platoon is different from a lead vehicle in the determined order and/or determining that a tail vehicle in the current order of the vehicles in the platoon is different from a tail vehicle in the determined order, controlling the vehicles such that the vehicles in the platoon are rearranged according to the determined order.

In an embodiment, a computer-readable medium may store one or more programs. The one or more programs, when executed by an electronic device for platooning of vehicles, may cause the electronic device to identify branch points for each of the vehicles on a route of the platooning, wherein the branch points are locations where the vehicles leave the platoon, identify distances from current positions of the vehicles to the branch points, determine an order of the vehicles in the platoon based on an ascending order of the identified distances, and based on determining that a lead vehicle in a current order of the vehicles in the platoon is different from a lead vehicle in the determined order and/or determining that a tail vehicle in the current order of the vehicles in the platoon is different from a tail vehicle in the determined order, control the vehicles such that the vehicles in the platoon are rearranged according to the determined order.

### BRIEF DESCRIPTION OF THE DRAWINGS

FIG. 1A schematically illustrates platooning vehicles.

FIGS. 1B and 1C illustrate an example of a conventional truck.

FIG. 2 is a block diagram of electronic devices for platooning of vehicles according to an embodiment.

FIGS. 3A, 3B, and 3C illustrate a formation of vehicles performing platooning according to an embodiment.

FIGS. 4A, 4B, and 4C illustrate a formation of vehicles performing platooning according to an embodiment.

FIGS. 5A, 5B, and 5C illustrate a formation of vehicles performing platooning according to an embodiment.

FIGS. 6A, 6B, and 6C illustrate a formation of vehicles performing platooning according to an embodiment.

FIGS. 7A and 7B illustrate a formation of vehicles performing platooning according to an embodiment.

FIG. 8 is a flowchart of an electronic device according to an embodiment.

FIG. 9 is a flowchart of an electronic device according to an embodiment.

FIG. 10 is a flowchart of an electronic device according to an embodiment.

FIG. 11 illustrates an example of a block diagram illustrating an autonomous driving system of a vehicle according to an embodiment.

FIGS. 12 and 13 illustrate an example of a block diagram indicating an autonomous driving moving object according to an embodiment.

FIG. 14 illustrates an example of a gateway related to a user device according to various embodiments.

FIG. 15 is a diagram for explaining an operation of an electronic device for training a neural network based on a set of learning data, according to an embodiment.

FIG. 16 is a block diagram of an electronic device according to an embodiment.

FIG. 17 is a flowchart of an electronic device according to an embodiment.

### DETAILED DESCRIPTION

Specific structural or functional descriptions of embodiments according to a concept of the present invention disclosed in the present specification are illustrated only for a purpose of describing the embodiments according to the concept of the present invention, and the embodiments according to the concept of the present invention may be implemented in various forms and are not limited to embodiments described in the present specification.

Since the embodiments according to the concept of the present invention may apply various changes and have various forms, the embodiments will be illustrated in the drawings and described in detail in the present specification. However, this is not intended to limit the embodiments according to the concept of the present invention to specific disclosure forms, and includes modifications, equivalents, or substitutes included in a spirit and a technical scope of the present invention.

Although terms such as ‘first’ or ‘second’ may be used to describe various components, the components should not be limited by the terms. The terms are only for a purpose of distinguishing one component from another component, for example, without departing from a scope of rights according to the concept of the present invention, a first component may be referred to as a second component, and similarly the second component may also be referred to as the first component.

When a component is said to be “connected” or “accessed” to another component, it should be understood that it may be directly connected or accessed to the other component, but still another component may exist in a middle. On the other hand, when a component is said to be “directly connected” or “directly connected” to another component, it should be understood that no other component exists in the middle. Expressions that describe a relationship between components, such as “between” and “directly between” or “directly adjacent to”, should be interpreted in the same way.

A term used in the present specification is used only to describe specific embodiments and is not intended to limit the present invention. Singular expressions include plural expressions unless context clearly indicates otherwise. In the present specification, a term such as “include” or “have”, and the like is intended to be designated as existence of a described feature, number, step, operation, component, part, or a combination thereof, and should be understood not to preclude a probability of the existence or addition of one or more other features, numbers, steps, operations, components, parts, or a combination thereof.

Unless otherwise defined, all terms used herein, including technical or scientific terms, have the same meaning as commonly understood by a person of ordinary skill in the art to which the present invention belongs. Terms defined in commonly used dictionaries should be interpreted as having a meaning consistent with the meaning of the context of relevant technology, and are not interpreted in an ideal or overly formal sense unless explicitly defined herein.

Hereinafter, embodiments will be described in detail with reference to the accompanying drawings. However, a scope of a patent application is not limited or restricted by these embodiments. The same reference numerals presented in each drawing may indicate the same configuration, and overlapping descriptions thereof may be omitted.

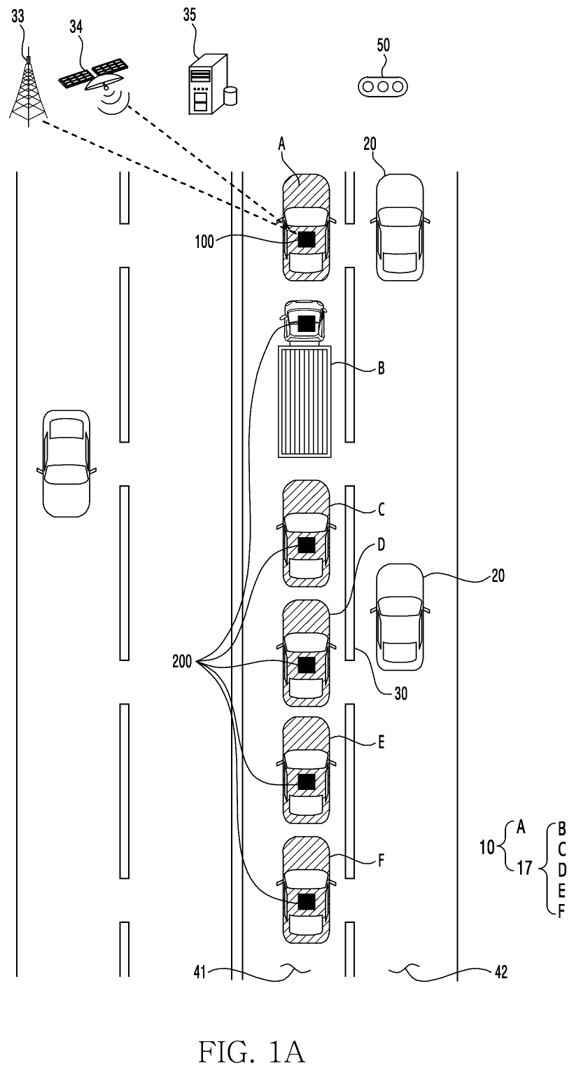

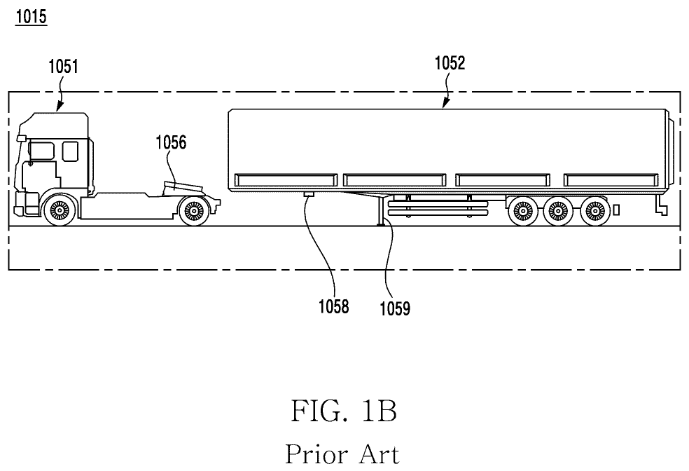

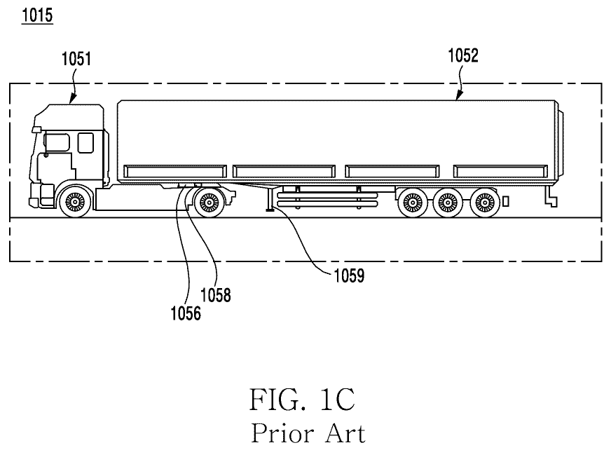

FIG. 1A schematically illustrates platooning vehicles.

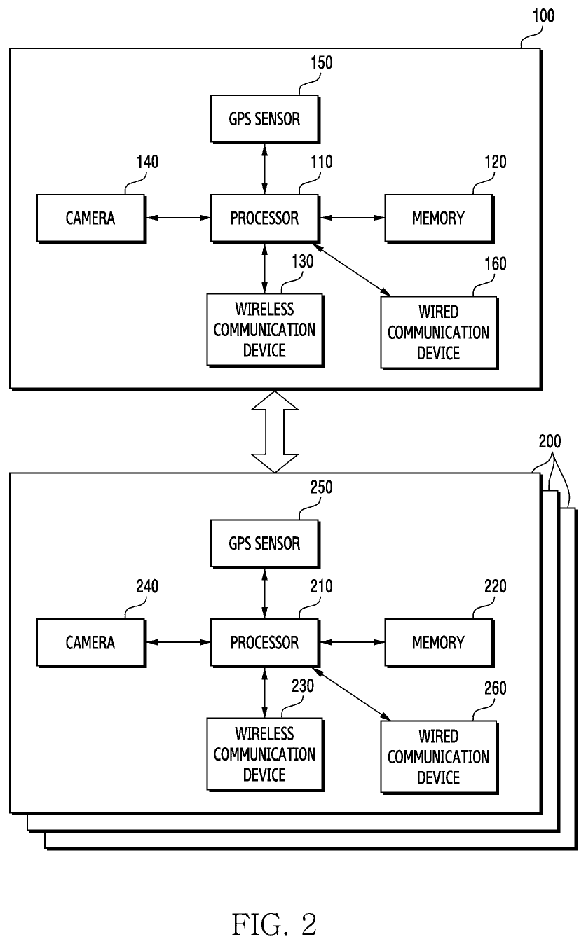

Platooning is a technology that controls two or more vehicles 10 forming a platoon to drive while maintaining a designated formation. Each of the vehicles 10 may include electronic devices (e.g., an electronic device 100 and other electronic devices 200 of FIG. 2) for the platooning. The electronic devices 100 and 200 may share control information of the vehicles 10 and information collected through the electronic devices 100 and 200 disposed in each of the vehicles 10 in real time using wireless communication technology. As the wireless communication technology for exchanging information between the electronic devices 100 and 200 illustrated in FIG. 1A, various wireless access technologies such as Vehicle to Everything (V2X) including Vehicle to Infrastructure (V2I), Vehicle to Device (V2D), Vehicle to Vehicle (V2V), Vehicle to Pedestrian (V2P), and the like, 5G New Radio (NR) Sidelink in a cellular manner, and Dedicated Short Range Communication (DSRC) based on 802.11 may be used.

The vehicles 10 may be distinguished into a vehicle A, which is a lead vehicle, and following vehicles 17. From among the platooning vehicles 10, the vehicle A may be referred to as a vehicle located at the front on a traveling route, and the following vehicles 17 may be referred to as remaining vehicles other than vehicle A. The electronic device 100 disposed in the vehicle A may be used to control an overall operation of the platooning. For example, since the vehicle A is disposed at the front in the platoon, the electronic device 100 may obtain more various information than the other electronic devices 200.

According to an embodiment, each of the vehicles 10 may be configured based on various shapes. For example, a shape of each of the vehicles 10 may be configured according to a vehicle type. The vehicle type may include a passenger car, a sports car, a military vehicle, a truck, a bus, a motorcycle, and a forklift. However, it is not limited thereto. For example, the vehicle A may be configured in a passenger car shape (e.g., a sedan). A vehicle B among the following vehicles 17 may be configured in a truck shape including a tractor and a trailer. A vehicle C, a vehicle D, a vehicle E, and a vehicle F among the following vehicles 17 may be configured in the passenger car shape. However, the vehicle type of each of the vehicles 10 is not limited by the above-described example.

The electronic device 100 may transmit and/or receive data with an external electronic device (e.g., a base station 33, a satellite 34, and/or a server 35). For example, the electronic device 100 may transmit and/or receive data with the server 35 through at least one of the base station 33 and/or the satellite 34.

For example, in order to determine a traveling route, the electronic device 100 may receive data including information related to the traveling route from the external electronic device (e.g., the base station 33, the satellite 34, and/or the server 35), and transmit data including information related to a real-time location of the platoon to the external electronic device (e.g., the base station 33, the satellite 34, and/or the server 35).

According to an embodiment, the base station 33 and/or the server 35 may be configured to manage the platooning of a designated area. For example, the base station 33 and/or the server 35 may be configured to manage traveling (or the platooning) of vehicles located within a cell defined based on coverage. The vehicles may be controlled through another base station and/or another server whenever the cell is changed. The vehicles may establish a connection (e.g., handover) with the other base station whenever the cell is changed.

According to an embodiment, the electronic device 100 may be configured to control the traveling of the vehicles 10 based on information (e.g., a traveling route, a traveling speed, a space between the vehicles 10, and/or a formation of the platoon) related to the platooning vehicles 10 and/or information (e.g., a road condition, other vehicles 20, a lane 30, and/or lanes 40 including a lane 41 and a lane 42) related to a surrounding environment. For example, the electronic device 100 may transmit a signal for controlling the platooning to each of the other electronic devices 200 disposed in each of the following vehicles 17. The other electronic devices 200 may be configured to control the traveling of the following vehicles 17 based on the signal received from the electronic device 100.

Each of the vehicles 10 may include various types of vehicles. The vehicles 10 may include a platooning section. Each of the vehicles 10 may pass a branch point leaving from the platooning section, according to a destination. Due to the leaving of any one vehicle in the middle of the platoon formed by the vehicles 10, a speed of the platooning of the vehicles 10 may be slowed or a probability of an accident may increase. In the following specification, a technical feature for controlling the vehicles 10 performing the platooning will be described.

Hereinafter, the electronic device 100 for controlling the vehicles 10 performing the platooning will be described with reference to the drawings. In the present disclosure, terms such as a first lane, a second lane, are simply used to distinguish lanes and are not limited to any further meaning.

FIGS. 1B and 1C illustrate an example of a conventional truck. For many years, a trucking industry has experienced steady growth and has expanded a range of services to respond to more complex supply chains. These services include last-mile deliveries, drop-trailer programs, and intermodal transportation (a transportation type in which freight is carried to a destination by two or more different means of transportation (a ship and a rail, a ship and an airplane)) at a port.

As such, since there are so many different ways to carry the freight, manufacturers of freight-related equipment have designed different types of equipment to carry the freight according to various transportation needs.

In the present specification, a truck that tows a trailer for a main purpose of a freight carry (or catering) is collectively referred to as a tractor.

The tractor described in the present specification may be classified into a conventional truck (or a bonneted truck), a cab-over truck (or a cab-over engine), and a semi-conventional truck, which is an intermediate form between the conventional truck and the cab-over truck, according to a location and a form of a cab of the tractor.

The conventional truck, which is a form in which an engine and a hood are positioned above a front axle in front of a cab of a tractor, and has a structure in which a driver sits behind the front axle, is a type of a tractor mainly used in North America where the engine of the tractor is located in front of the driver.

On the other hand, the cap over truck, which has a structure in which a cap of a tractor is located to a front end of the tractor and a driver sits in front of a front axle, and is a form a so-called “flat face (or flat nose)” in which a front of the tractor is flat, is a form of a tractor mainly used in most countries, such as Europe and Asia where an engine of the tractor is located under the driver.

Just as there are various forms according to a purpose and a demand of a tractor, there are various forms of trailers towed by the tractor. Among them, the most representative types of trailers are a full-trailer and a semi-trailer. The full trailer and the semi-trailer may be distinguished by whether the trailer is equipped with both a front axle and a rear axle. This trailer may be connected to a box truck or a tractor through a coupling device.

To explain specifically, the full trailer is a commercial freight trailer equipped with both the front axle and the rear axle. The full trailer may fully support its own weight without relying on a tractor by being to support an entire load only with the trailer, is equipped with a drawbar to be coupled to a towing unit (or a hauling unit) such as the tractor, and is mainly used in the United States and Canada and the like.

On the other hand, the semi-trailer, which is a freight trailer with only a rear axle without a front axle, may support a large portion of a load by a tractor connected by a kind of hitch called a “fifth wheel” ( [symbol] ). In case of being in a stationary state by being detached from the tractor, the semi-trailer may support the load of the trailer by spreading a landing gear mounted on a lower portion of the semi-trailer vertically to the ground. A combination of the semi-trailer and the tractor is called a semi-trailer truck (also called simply a “semi-trailer”, a “tractor-trailer”, a “semi-truck”, a “big rig”, or a “semi” in the United States). The above-described “Fifth wheel” refers to a horizontal wheel attached to a tractor axle of a trailer truck to facilitate a direction change of the trailer, and is also called a fifth wheel. The “Fifth wheel” is a device that enables a movable coupling ( [symbol] ) of the tractor and the semi-trailer and includes a lower portion consisting of a trunnion plate and a clasp ( [symbol] ) device that firmly fixes a kingpin mounted on the semi-trailer to the tractor.

Hereinafter, in the present specification, based on the terms of the tractors/trailers described above, for convenience of explanation, “trailer” will be used to mean a freight transport vehicle connected to a tractor for a trailer, and “trailer” will be used as a tow vehicle for moving the trailer. In addition, in the present invention, in order to exclude a limitation of rights according to an embodiment described in a detailed description as much as possible, a tractor hauling/towing a “trailer” may be described interchangeably with a term “towing vehicle,” a trailer towed by a tractor may be described interchangeably with a term “towed vehicle”.

Also, for convenience of explanation, it is desirable to understand that the “trailer” described throughout the present specification refers to a “semi-trailer,” but is not limited thereto.

Referring to FIGS. 1B and 1C, a vehicle 1015 may be an example of the vehicle B of FIG. 1A described above. The vehicle 1015 may include a tractor or tractor unit 1051 and a semi-trailer 1052. FIG. 1B illustrates a state in which the tractor 1051 and the semi-trailer 1052 are not connected, and FIG. 1C illustrates a state in which the tractor 1051 and the semi-trailer 1052 are connected.

In an embodiment, the semi-trailer 1052 may be selectively connected by a fifth wheel hitch 1056 carried by the tractor 1051, and the fifth wheel hitch 1056 may be fastened to the kingpin 1058 fixed to the semi-trailer 1052 according to a known manner. The vehicle 1015 including the tractor 1051 and the semi-trailer 1052 may be referred to as a truck. The vehicle 1015 may include only the tractor 1051. The semi-trailer 1052 illustrated in FIGS. 1B and 1C illustrated a form of the “semi-trailer”, but this is for convenience of explanation, and an embodiment of the present disclosure should not be understood as being applied only to the form of the “semi-trailer”. The tractor 1051 illustrated in FIGS. 1B and 1C illustrated a form of the “cap-over truck,” but this is for convenience of explanation, and the embodiment of the present disclosure should not be understood as being applied only to the form of the “cap-over truck.”

In an embodiment, the semi-trailer 1052 may include the king pin 1058 coupled to the fifth wheel hitch 1056 of the tractor 1051, and a landing gear 1059 supporting the semi-trailer 1052 from the ground in a state in which the semi-trailer 1052 is not coupled to the tractor 1051. The king pin 1058 and the landing gear 1059 may be installed (or disposed) in a lower portion of the semi-trailer 1052.

In an embodiment, the semi-trailer 1052 may be rotatably coupled to the tractor 1051 to support traveling on a curved road. For example, the tractor 1051 and the semi-trailer 1052 may be rotatably coupled through a coupling device including the fifth wheel hitch 1056 and the king pin 1058. However, a link mechanism between the tractor 1051 and the semi-trailer 1052 is not limited thereto.

FIG. 2 is a block diagram of electronic devices for platooning of vehicles according to an embodiment.

Referring to FIG. 2, an electronic device 100 according to an embodiment may include a processor 110, memory 120, a wireless communication device 130, a camera 140, a Global Positioning System (GPS) sensor 150, and/or a wired communication device 160. The electronic device 100 according to an embodiment may be referred to as an electronic device disposed in a lead vehicle (e.g., the vehicle A of FIG. 1A).

For example, the processor 110, the memory 120, the wireless communication device 130, the camera 140, the GPS sensor 150, and/or the wired communication device 160 may be electronically and/or operably coupled with each other by an electronical component such as a communication bus. Hereinafter, hardware being operatively coupled may mean that a direct connection or an indirect connection between the hardware is established by wire or wirelessly so that second hardware is controlled by first hardware among the hardware.

In FIG. 2, the processor 110, the memory 120, the camera 140, the wireless communication device 130, the GPS sensor 150, and/or the wired communication device 160 are illustrated in different blocks, but are not limited thereto. Some of the hardware illustrated in FIG. 2 may be implemented as a single integrated circuit or as portion of a single package, such as a system on a chip (SoC).

According to an embodiment, the memory 120 may store instructions. The processor 110 may be configured to process data based on the instructions stored in the memory 120. For example, the processor 110 may include an arithmetic and logic unit (ALU), a floating point unit (FPU), a field programmable gate array (FPGA), a central processing unit (CPU), and/or an application processor (AP). The processor 110 may have a structure of a single-core processor 110, or may have a structure of a multi-core processor such as a dual core, a quad core, a hexa core, or an octa core.

According to an embodiment, the memory 120 may include a hardware component for storing data and/or instructions that may be executed by the processor 110. For example, the memory 120 may include a volatile memory such as random-access memory (RAM) and/or a non-volatile memory such as read-only memory (ROM). For example, the volatile memory may include at least one of dynamic RAM (DRAM), static RAM (SRAM), cache RAM, and pseudo SRAM (PSRAM). For example, the non-volatile memory may include at least one of programmable ROM (PROM), erasable PROM (EPROM), electrically erasable PROM (EEPROM), flash memory, a hard disk, a compact disk, a solid state drive (SSD), and an embedded multi-media card (eMMC). For example, the memory 120 of the electronic device 100 may include a neural network model. The electronic device 100 may identify an external object (e.g., a lane (e.g., the lane 30 of FIG. 1A), a lane (e.g., the lanes 40 of FIG. 1A), other vehicles (e.g., the other vehicles 20 of FIG. 1A) and/or traffic lights (e.g., the traffic light 50 of FIG. 1A) based on the neural network model stored in the memory 120.

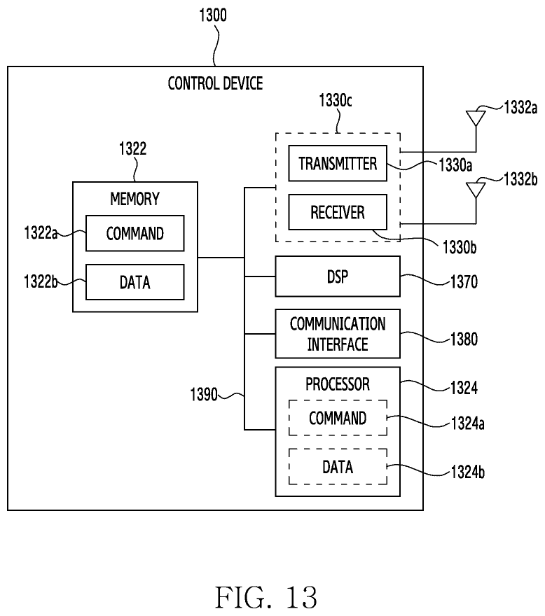

According to an embodiment, the wireless communication device 130 may be used for wireless communication with other electronic devices 200 and/or an external electronic device. For example, the electronic device 100 may be configured to wirelessly communicate with an external electronic device (e.g., a base station (e.g., the base station 33 of FIG. 1A), a satellite (e.g., the satellite 34 of FIG. 1A), and/or a server (e.g., the server 35 of FIG. 1A)) and the other electronic devices 200 using the wireless communication device 130. The wireless communication device 130 may be electrically connected with an antenna (e.g., an antennas 1332a or 1332b of FIG. 13) for transmitting and/or receiving a signal. The wireless communication device 130 may convert an analog signal provided from the processor 110 into a digital signal and upconvert a baseband signal into a radio frequency (RF) signal. The electronic device 100 may obtain information related to a real-time location of a platoon using the GPS sensor 150, and transmit data including the information to the external electronic device using the wireless communication device 130. The electronic device 100 may transmit a signal for controlling traveling of following vehicles (e.g., the following vehicles 17 of FIG. 1A) to a wireless communication device 230 of the other electronic devices 200. The other electronic devices 200 may receive the signal through the wireless communication device 230.

According to an embodiment, the camera 140 may include a lens assembly or an image sensor. The lens assembly may collect light emitted from a subject which is a target of image capturing. The lens assembly may include one or more lenses. For example, the camera 140 may include a plurality of lens assemblies. For example, in the camera 140, a portion the plurality of lens assemblies may have identical lens properties (e.g., an angle of view, a focal length, an autofocus, an f number, or an optical zoom), or at least one lens assembly may have one or more lens properties different from lens properties of another lens assembly. The lens assembly may include a wide-angle lens or a telephoto lens. For example, the electronic device 100 may include a flash for the camera 140. The flash may include one or more light emitting diodes (e.g., a red-green-blue (RGB) LED, a white LED, an infrared LED, or an ultraviolet LED), or a xenon lamp. For example, the image sensor may obtain an image corresponding to the subject by converting light emitted or reflected from the subject and transmitted through the lens assembly into an electrical signal. According to an embodiment, the image sensor may include, for example, one image sensor selected from among image sensors in which a property is different, such as an RGB sensor, a black and white (BW) sensor, an IR sensor, or a UV sensor, a plurality of image sensors having an identical property, or a plurality of image sensors having a different property. Each image sensor included in the image sensor may be implemented, for example, using a charged coupled device (CCD) sensor or a complementary metal oxide semiconductor (CMOS) sensor.

According to an embodiment, the electronic device 100 may identify surrounding environments of the vehicle A using the camera 140. For example, the electronic device 100 may identify an external object based on an image obtained through camera 140. For example, the electronic device 100 may identify the external object corresponding to the image from the image obtained through the camera 140 using the neural network model. For example, the electronic device 100 may obtain an image corresponding to the other vehicles 20 traveling in another lane (e.g., the lane 42 of FIG. 1A) through the camera 140, and identify the other vehicles 20 in the lane 42 from the image.

According to an embodiment, the wired communication device 160 may be used to connect the electronic device 100 and control circuitry (e.g., an electronic control unit (ECU)) of the vehicle A. For example, the electronic device 100 may transmit a signal for controlling the vehicle A to the control circuitry of the vehicle A using the wired communication device 160. The electronic device 100 may control the vehicle A using the control circuitry connected with the wired communication device 160.

The other electronic devices 200 disposed in the following vehicles 17 may include substantially the same components as the electronic device 100 disposed in the vehicle A. For example, each of the other electronic devices 200 may include a processor 210, memory 220, a wireless communication device 230, a camera 240, a GPS sensor 250, and/or a wired communication device 260. The above-described descriptions with respect to components of the electronic device 100 may be applied to components of the other electronic devices 200 in substantially the same manner.

Since the vehicles 10 drive in a designated formation, the camera 240 of the other electronic devices 200 may obtain an image that the camera 140 of the electronic device 100 cannot obtain, at a specific timing. According to an embodiment, the other electronic devices 200 may transmit information related to the image obtained through the camera 240 and/or information related to the external object identified from the image, to the electronic device 100. The electronic device 100 may identify the surrounding environments of the platoon based on the information received from the other electronic devices 200, and control the traveling of the platoon based on the surrounding environments.

According to an embodiment, the electronic device 100 may change the formation using the neural network model. For example, the processor 110 may determine whether to change the formation based on information (e.g., first environment information) related to the surrounding environments of the vehicle A and information (e.g., second environment information) received from the following vehicles 17, obtained using the camera 140. For example, on a travel route for the platooning, in case that a traffic flow is not smooth, the processor 110 may change the formation or a traveling method (e.g., a speed, the travel route) for the platooning. For example, the processor 110 may change the formation or the traveling method for the platooning, based on a state (e.g., an amount of remaining fuel, a tire pressure, or an engine oil pressure) of the vehicles 10.

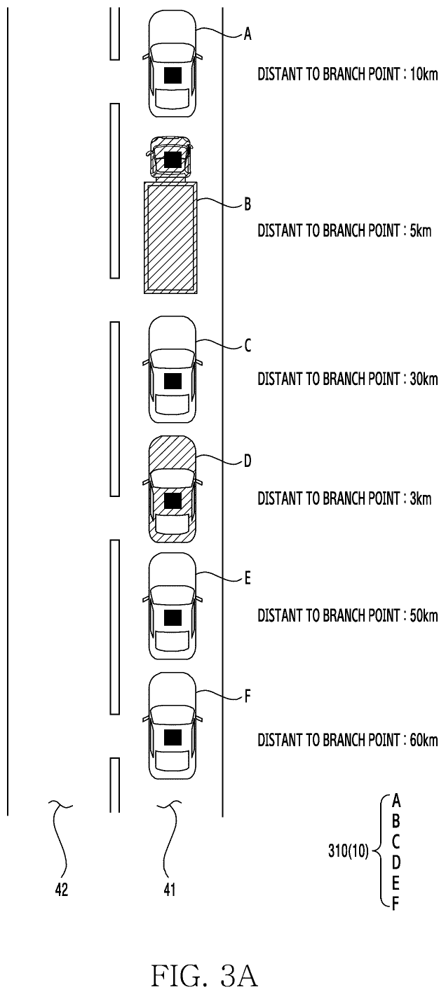

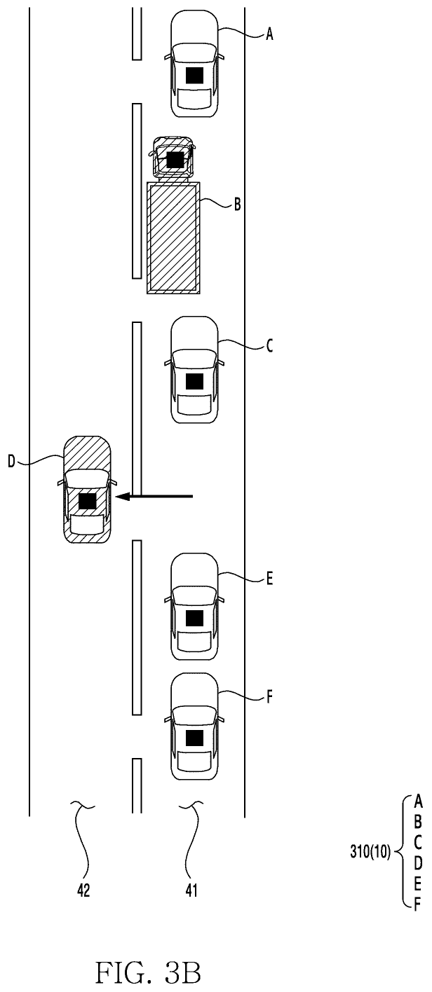

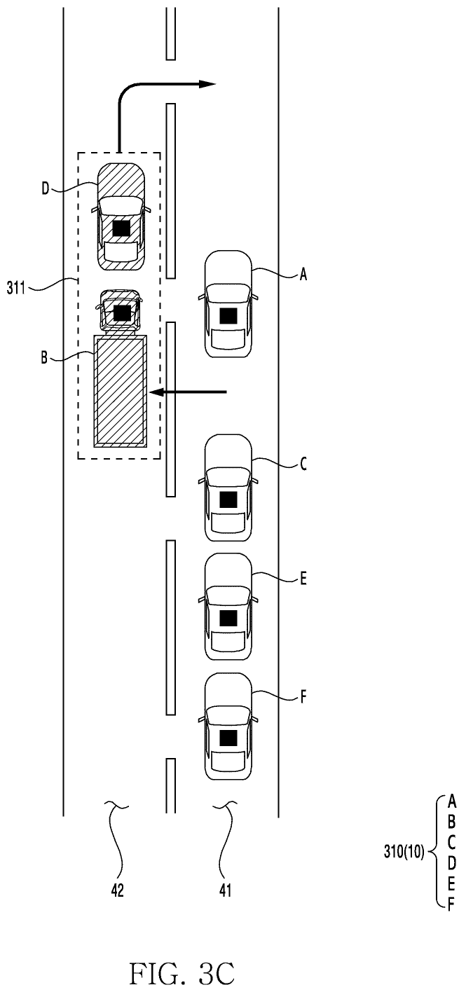

FIGS. 3A, 3B, and 3C illustrate a formation of vehicles performing platooning according to an embodiment.

FIGS. 3A, 3B, and 3C illustrate vehicles 10 as time elapses. For example, FIG. 3A illustrates the vehicles 10 at a first timing, FIG. 3B illustrates the vehicles 10 at a second timing, and FIG. 3C illustrates the vehicles 10 at a third timing after the second timing.

Referring to FIGS. 3A, 3B, and 3C, in order to perform the platooning, the vehicles 10 may configure a platoon 310. For example, the platoon 310 may include vehicles A, B, C, D, E, and F. Although an example including six vehicles is illustrated, the number of the vehicles 10 is not limited thereto, and the number of the vehicles 10 may be variously set. A shape of the vehicles 10 is for convenience of explanation and is not limited by the illustrated example.

Operations described below may be performed by an electronic device (e.g., the electronic devices 100 and 200) and/or a processor (e.g., the processors 110 and 210) included in each of the vehicles 10. However, for convenience, it has been described that the following operations are performed by each of the vehicles 10.

In an embodiment, the vehicle A may control the vehicles 10 based on transmitting a signal to other vehicles B, C, D, E, and F. In an example, the vehicle A may control the vehicle B based on transmitting a signal to the other vehicles B, C, D, E, and F. For example, the vehicle A may control the vehicle C based on transmitting a signal to the other vehicles B, C, D, E, and F. For example, the vehicle A may control the vehicle D based on transmitting a signal to the other vehicles B, C, D, E, and F. For example, the vehicle A may control the vehicle E based on transmitting a signal to the other vehicles B, C, D, E, and F. For example, the vehicle A may control the vehicle F based on transmitting a signal to the other vehicles B, C, D, E, and F.

In the following specification, for convenience of explanation, an operation in which the vehicle A controls the vehicles 10 by transmitting a signal to the other vehicles B, C, D, E, and F will be described as an operation in which the vehicle A controls the vehicles 10.

According to an embodiment, the vehicle A may control the vehicles 10 to perform the platooning. The vehicle A may configure the vehicles 10 as a group. The vehicle A may control the configured group to move to an identical route. For example, the vehicle A may identify a route in which the vehicles 10 will travel to a destination.

In an embodiment, the vehicle A may identify branch points of each of the vehicles 10 on a route of the platooning. For example, the vehicle A may obtain information regarding destinations of the vehicles 10 from each of the vehicles 10 and, based on the obtained information, identify a branch point of each of the vehicles 10. The branch point may be a location where the vehicle leaves the platoon 310. For example, the branch point may be a point (or location) where a vehicle leaves from a route of the platooning to another route.

Referring to FIG. 3A, in an embodiment, the vehicle A may identify distances from current locations of the vehicles 10 to the branch points. For example, a distance to a branch point of the vehicle A may be 10 km. For example, a distance to a branch point of the vehicle B may be 5 km. For example, a distance to a branch point of the vehicle C may be 30 km. For example, a distance to a branch point of the vehicle D may be 3 km. For example, a distance to a branch point of the vehicle E may be 50 km. For example, a distance to a branch point of the vehicle F may be 60 km. However, a distance to the branch points of the illustrated vehicles 10 is only for explaining a scenario for controlling the platooning, and the branch points of the vehicles 10 are not limited by the example.

The route illustrated in FIG. 3A may be composed of two lanes 40. The two lanes 40 may include a lane 41 and a lane 42. At the timing of FIG. 3A, the vehicles 10 may be in a state of traveling in the lane 41.

In an embodiment, the vehicle A may rearrange an order of the vehicles 10 configuring the platoon 310. For example, the vehicle A may determine the order of the vehicles 10 in platoon 310, based on an ascending order of distances to the branch point.

In an embodiment, the vehicle A may identify at least one vehicle that has to leave a lane in which the platoon 310 is traveling in order for the vehicles 10 to be rearranged according to the determined order, based on an insertion sort algorithm. For example, in the example of FIG. 3A, since the vehicle B has a smaller distance to the branch point than the vehicle A, which is a preceding vehicle, and the vehicle D has a smaller distance to the branch point than the vehicle C, which is a preceding vehicle, the vehicles B and D may have to leave the lane 41 in which the platoon 310 is traveling for rearrangement.

In an embodiment, the vehicle A may identify whether there are vehicles whose distances to the branch points are less than a reference value among vehicles in which leaving for rearrangement is required. For a non-limiting example, the reference value may be 1 km. In an embodiment, the vehicle A may change the determined order such that a corresponding vehicle(s) is arranged in the ascending order of distances from a tail to the branch point, based on identifying the vehicle(s) among the vehicles 10 whose distances to the branch points are less than the reference value. In the example of FIG. 3A, among the vehicles B and D that need to leave the platoon 310 for the rearrangement, a vehicle less than the reference value may not exist. Accordingly, the vehicle A may determine the order of the vehicles 10 in an order continuing from a head to the vehicles D, B, A, C, E, and F.

In an embodiment, the vehicle A may determine whether a lead vehicle (e.g., the vehicle A) in a current order of the vehicles 10 in the platoon 310 is different from a lead vehicle (e.g., the vehicle D) in the determined (or changed) order and/or whether a tail vehicle (e.g., the vehicle F) in the current order of the vehicles 10 in the platoon 310 is different from a tail vehicle (e.g., the vehicle F) in the determined (or changed) order.

In an embodiment, in case of determining that the lead vehicle is different or/or the tail vehicle is different, the vehicle A may control the vehicles 10 to rearrange the vehicles 10 in the platoon 310 in the determined order. Alternatively, in case that both the lead vehicle and the tail vehicle are not changed, the vehicle A may control the vehicles 10 so that the current order of the vehicles 10 in the platoon 310 is maintained.

In the example of FIG. 3A, a tail vehicle of the platoon 310 is the same as the vehicle F, but since a lead vehicle changes from the vehicle A to the vehicle D, the vehicles 10 may control the vehicles 10 to be rearranged in an order of the vehicles D, B, A, C, E, and F from the lead vehicle.

In an embodiment, the vehicle A may determine the at least one vehicle that needs to leave the platoon 310 as a first group where a distance to the branch point exceeds the reference value (e.g., 1 km) and/or as a second group where a distance to the branch point does not exceed the reference value. In the example of FIG. 3A, since the distances to the branch points of the vehicles B and D that need to leave the platoon 310 are 5 km and 3 km, which exceed the reference value, the vehicles B and D may be determined as the first group.

In an embodiment, in case that the first group includes a first plurality of vehicles, the vehicle A may control the vehicles 10 such that the first plurality of vehicles form a first sub-platoon in another lane different from a lane in which the platoon 310 is traveling, and subsequently merge at a head of the platoon 310.

In an embodiment, in case that the first group includes only one vehicle, the vehicle A may control the vehicles 10 such that a corresponding vehicle leaves the lane in which the platoon 310 is traveling and subsequently merges at a head of the platoon.

In the example of FIG. 3A, the first group may include the plurality of vehicles B and D. Therefore, referring to FIGS. 3B and 3C, the vehicle A may control the vehicles 10 such that the vehicles B and D form a first sub-platoon 311 in another lane 42 different from the lane 41 in which the platoon 310 is traveling, and subsequently merge at the head of the platoon 310.

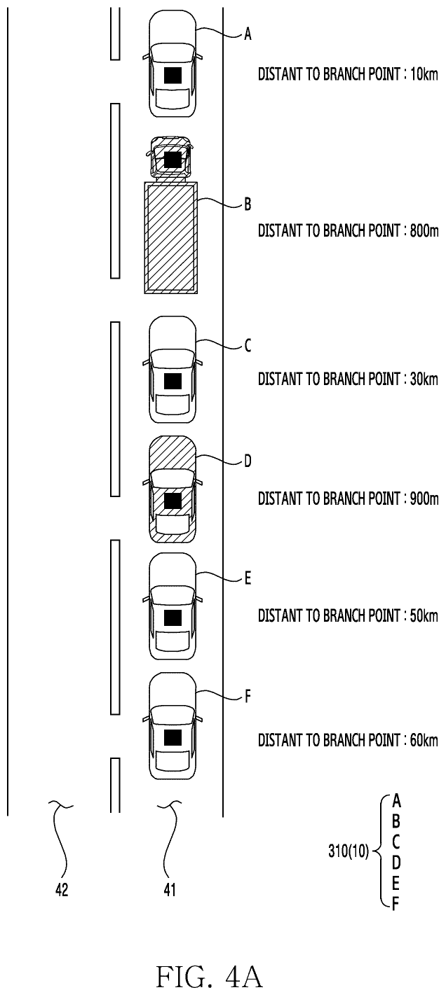

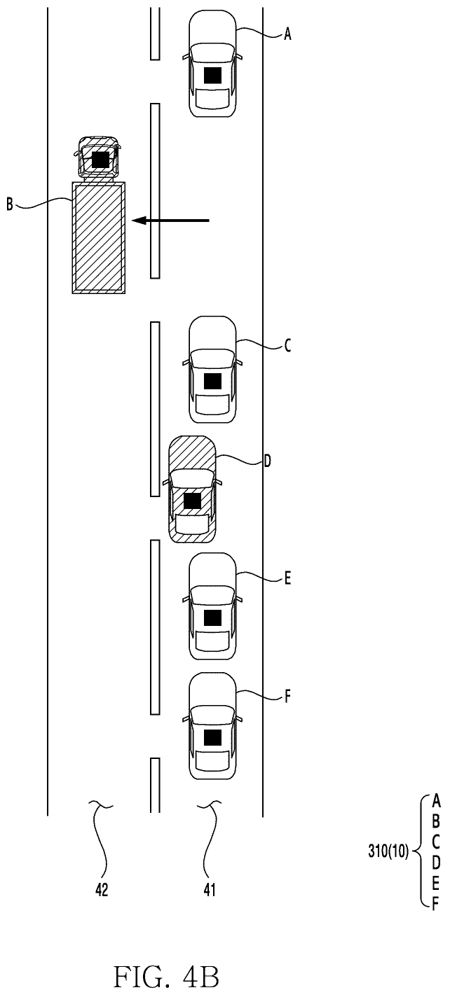

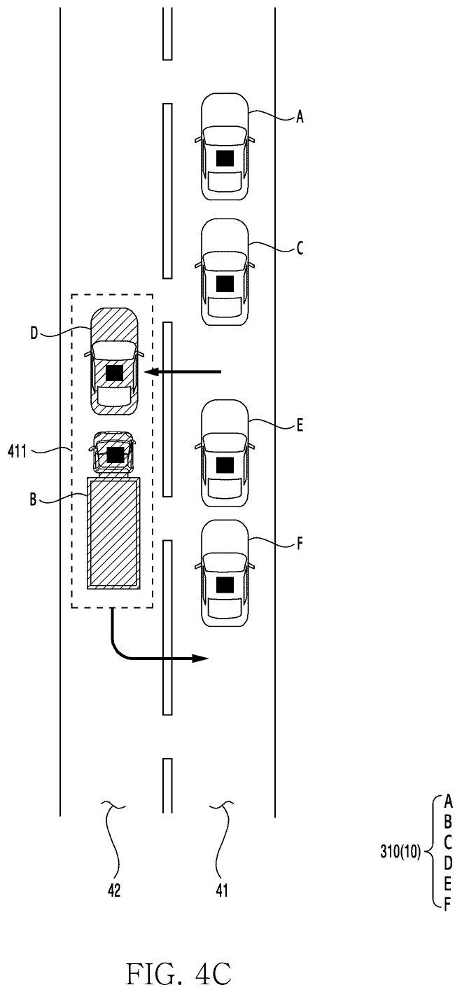

FIGS. 4A, 4B, and 4C illustrate a formation of vehicles performing platooning according to an embodiment.

FIGS. 4A, 4B, and 4C illustrate vehicles 10 as time elapses. For example, FIG. 4A illustrates the vehicles 10 at a first timing, FIG. 4B illustrates the vehicles 10 at a second timing, and FIG. 4C illustrates the vehicles 10 at a third timing after the second timing.

Referring to FIG. 4A, a distance to a branch point of a vehicle A may be 10 km. For example, a distance to a branch point of a vehicle B may be 800 m. For example, a distance to a branch point of a vehicle C may be 30 km. For example, a distance to a branch point of a vehicle D may be 900 m. For example, a distance to a branch point of a vehicle E may be 50 km. For example, a distance to a branch point of a vehicle F may be 60 km. However, a distance to the branch points of the illustrated vehicles 10 is only for explaining a scenario for controlling the platooning, and the branch points of the vehicles 10 are not limited by the example.

In an embodiment, the vehicle A may determine an order of the vehicles 10 as the vehicles B, D, A, C, E, and F according to an ascending order of the distances to the branch point.

In an embodiment, vehicles that have to leave for rearrangement among the vehicles 10 may be the vehicles B and D. The vehicles D and B have a A distance to the branch point less than or equal to a reference value (e.g., 1 km). Accordingly, the vehicle A may change the order of the vehicles 10 such that the vehicles B and D may be arranged in the ascending order of distances from a tail of a platoon 310 to the branch point. The changed order may be the vehicles A, C, E, F, D, and B from a head.

In an embodiment, by the change of the order of the vehicles 10, a lead vehicle may be identical as the vehicle A, but a tail vehicle may be changed from the vehicle F to the vehicle B. Accordingly, the vehicle A may control the vehicles 10 to be rearranged in the order of the vehicles A, C, E, F, D, and B from the head.

In an embodiment, the vehicle A may determine the vehicles B and D that need to leave the platoon 310 as a second group where a distance to the branch point does not exceed the reference value.

In an embodiment, in case that the second group includes a second plurality of vehicles, the vehicle A may control the vehicles 10, such that the second plurality of vehicles form a second sub-platoon in another lane different from a lane in which the platoon 310 is traveling, and subsequently merge at the tail of the platoon 310.

In an embodiment, in case that the second group includes only one vehicle, the vehicle A may control the vehicles such that a corresponding vehicle merges at the head of the platoon 310 in the lane in which the platoon 310 is traveling.

In the example of FIG. 4A, the second group may include the plurality of vehicles B and D. Therefore, referring to FIGS. 4B and 4C, the vehicle A may control the vehicles 10 such that the vehicles B and D form a second sub-platoon 411 in another line 42 different from a lane 41 in which the platoon is traveling, and subsequently merge at the tail of the platoon 310.

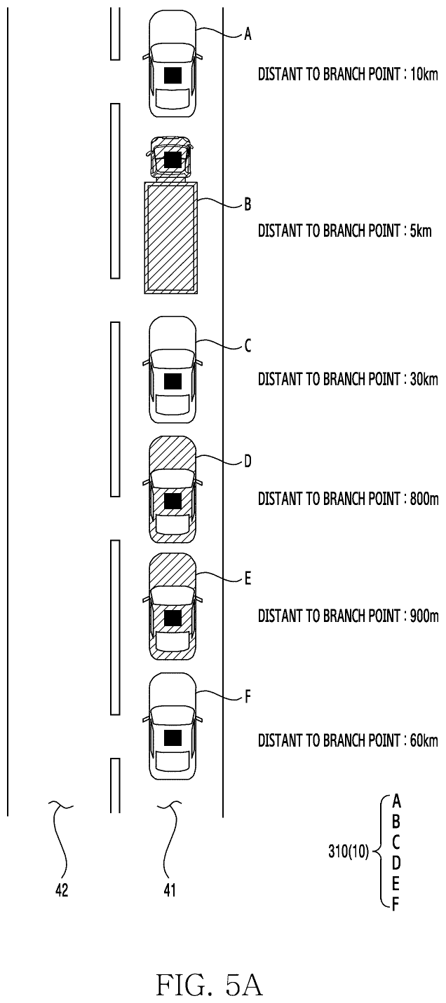

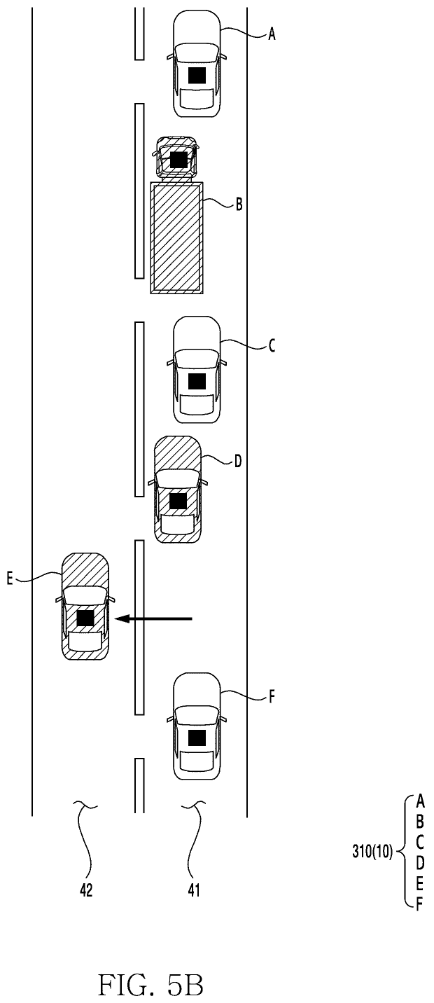

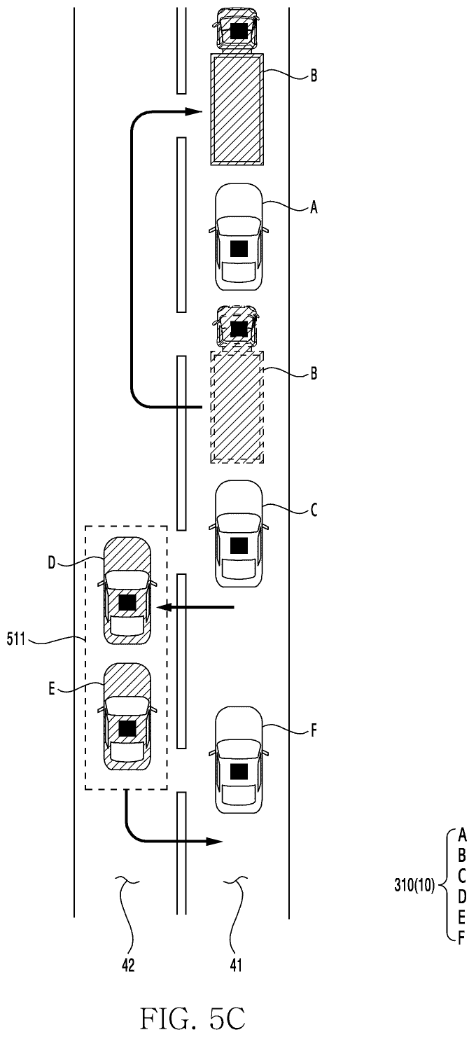

FIGS. 5A, 5B, and 5C illustrate a formation of vehicles performing platooning according to an embodiment.

FIGS. 5A, 5B, and 5C illustrate vehicles 10 as time elapses. For example, FIG. 5A illustrates the vehicles 10 at a first timing, FIG. 5B illustrates the vehicles 10 at a second timing after the first timing, and FIG. 5C illustrates the vehicles 10 at a third timing after the timing.

Referring to FIG. 5A, a distance to a branch point of a vehicle A may be 10 km. For example, a distance to a branch point of a vehicle B may be 5 km. For example, a distance to a branch point of a vehicle C may be 30 km. For example, a distance to a branch point of a vehicle D may be 800 m. For example, a distance to a branch point of a vehicle E may be 900 m. For example, a distance to a branch point of a vehicle F may be 60 km. However, a distance to the branch points of the illustrated vehicles 10 is only for explaining a scenario for controlling the platooning, and the branch points of the vehicles 10 are not limited by the example.

In an embodiment, the vehicle A may determine an order of the vehicles 10 as the vehicles D, E, B, A, C, and F according to an ascending order of the distances to the branch point.

In an embodiment, the vehicles have to leave for rearrangement among the vehicles 10 may be the vehicles B, D, and E. The vehicles D and E may have a distance to the branch point less than or equal to a reference value (e.g., 1 km), and the vehicle B may have a distance to the branch point exceeding the reference value. Accordingly, the vehicle A may change the order of the vehicles 10 such that the vehicles D and E may be arranged in the ascending order of distances from a tail of a platoon 310 to the branch point. The changed order may be the vehicles B, A, C, F, D, and E from a head.

A lead vehicle was changed from the vehicle A to the vehicle B, and the tail vehicle may be changed from the vehicle F to the vehicle E, by the change of the order of the vehicles 10. Accordingly, the vehicle A may control the vehicles 10 to be rearranged in the order of the vehicles B, A, C, F, D, and E from the head.

In an embodiment, the vehicles 10 may determine a vehicle that needs to leave the platoon 310 as a first group where a distance to the branch point exceeds the reference value and/or as a second group where a distance to the branch point does not exceed the reference value.

In an embodiment, the vehicle A may determine the vehicles D and E as the second group where the distance to the branch point is less than or equal to the reference value. In addition, vehicle A may determine the vehicle B as the first group where the distance to the branch point exceeds the reference value.

Referring to FIGS. 5B and 5C, in an embodiment, since the first group includes only the one vehicle B, the vehicle A may control the vehicles 10 such that a corresponding vehicle leaves a lane 41 in which the platoon 310 is traveling and subsequently merges at the head of the platoon.

In addition, the vehicle A may control vehicles 10 such that the vehicles D and E form a third sub-platoon 511 in another lane 42 different from the lane 41 in which the platoon 310 is traveling, and subsequently merge at the tail of the platoon 310.

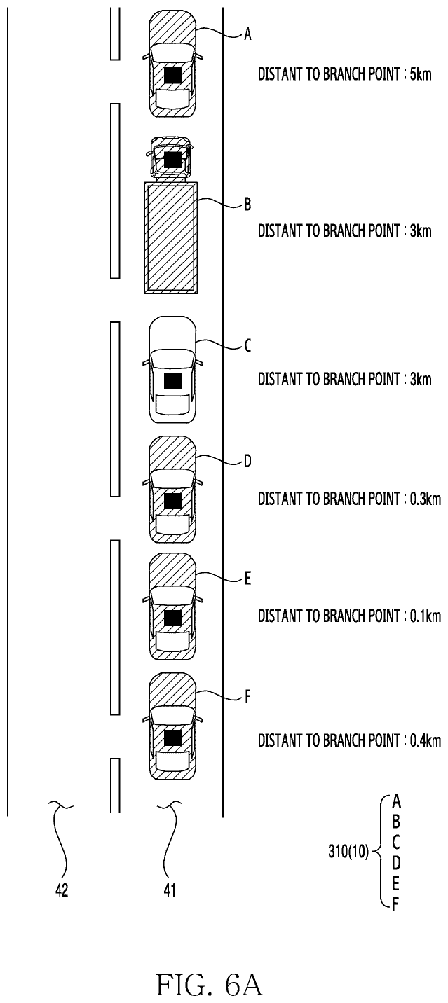

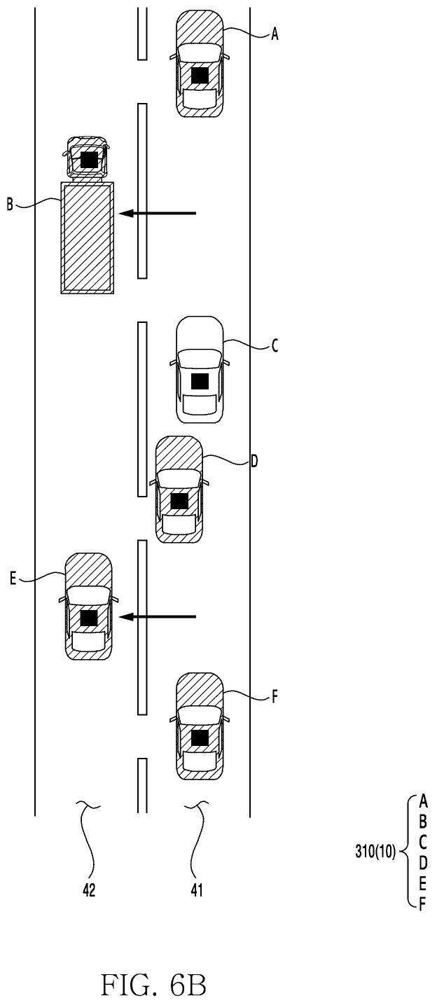

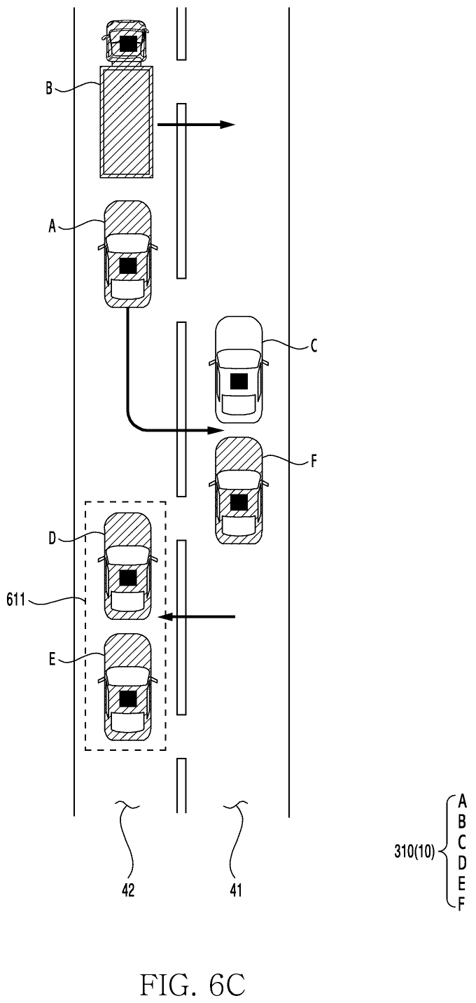

FIGS. 6A, 6B, and 6C illustrate a formation of vehicles performing platooning according to an embodiment.

FIGS. 6A, 6B, and 6C illustrate vehicles 10 as time elapses. For example, FIG. 6A illustrates the vehicles 10 at a first timing, FIG. 6B illustrates the vehicles 10 at a second timing, and FIG. 6C illustrates the vehicles 10 at a third timing after the second timing.

Referring to FIG. 6A, a distance to a branch point of a vehicle A may be 5 km. For example, a distance to a branch point of a vehicle B may be 3 km. For example, a distance to a branch point of a vehicle C may be 3 km. For example, a distance to a branch point of a vehicle D may be 0.3 km. For example, a distance to a branch point of a vehicle E may be 0.1 km. For example, a distance to a branch point of a vehicle F may be 0.4 km. However, a distance to the branch points of the illustrated vehicles 10 is only for explaining a scenario for controlling the platooning, and the branch points of the vehicles 10 are not limited by the example.

In an embodiment, the vehicle A may determine an order of the vehicles 10 as the vehicles E, D, F, B, C, and A according to an ascending order of the distances to the branch point.

In an embodiment, vehicles that have to leave for rearrangement among the vehicles 10 may be the vehicles A, B, D, E, and F. The vehicles D, E, and F may have a distance to the branch point less than or equal to a reference value (e.g., 1 km), and the vehicles A and B may have a distance to the branch point exceeding the reference value. Accordingly, the vehicle A may change the order of the vehicles 10 such that the vehicles D, E, and F may be arranged in the ascending order of distances from a tail of a platoon 310 to the branch point. The changed order may be the vehicles B, C, A, F, D, and E from a head.

A lead vehicle was changed from the vehicle A to the vehicle B, and a tail vehicle may be changed from the vehicle F to the vehicle E, by the change of the order of the vehicles 10. Accordingly, the vehicle A may control the vehicles 10 to be rearranged in the order of the vehicles B, C, A, F, D, and E from the head.

In an embodiment, the vehicle A may determine the vehicles A and B where a distance to the branch point exceeds the reference value (e.g., 1 km) as a first group, and determine the vehicles D, E, and F where a distance to the branch point does not exceed the reference value (e.g., 1 km) as a second group.

In an embodiment, in case that the first group or the second group includes a third plurality of vehicles exceeding a reference number, the vehicle A may identify a specific vehicle having the largest distance to the branch point among corresponding vehicles. The reference number may be, for a non-limiting example, three.

In an embodiment, the vehicle A may control the vehicles 10 such that the specific vehicle maintains the platooning, and may control the vehicles 10 such that remaining vehicles may form a sub-platoon in another lane 42 different from a lane 41 in which the platoon 310 is traveling, and subsequently merge at the tail of the platoon 310.

In an embodiment, the first group may include the vehicles A and B that do not exceed the reference number. Accordingly, referring to FIGS. 6A and 6B, the vehicle A may control the vehicles 10 such that the vehicles A and B leave the lane 41 in which the platoon 310 is traveling and subsequently merge at the platoon 310 in the determined order.

In an embodiment, the second group may include the vehicles D, E, and F exceeding the reference number. The vehicle A may identify the vehicle F having the farthest distance to the branch point among the vehicles D, E, and F as the specific vehicle. Accordingly, the vehicle A may control the vehicles 10 such that the vehicle F maintains the platooning in the lane 41, and the vehicles D and E form a fourth sub-platoon 611 in the other lane 42 different from the lane 41 in which the platoon 310 is traveling, and subsequently merge at the tail of the platoon 310.

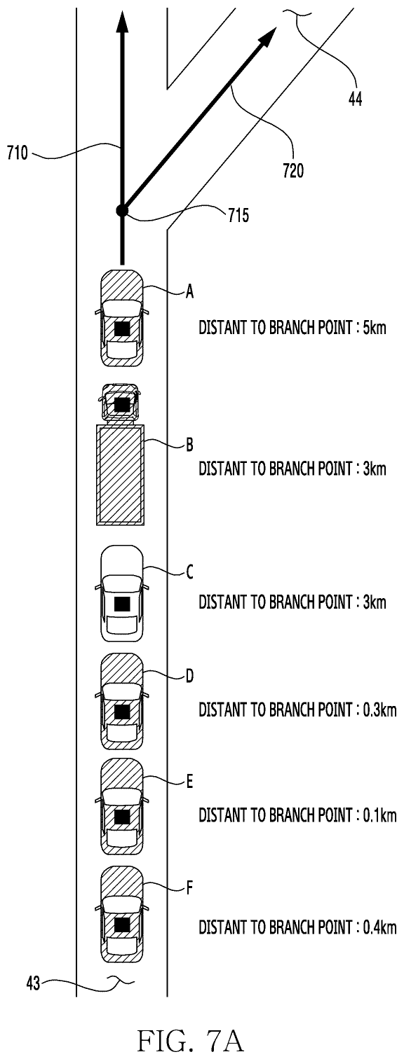

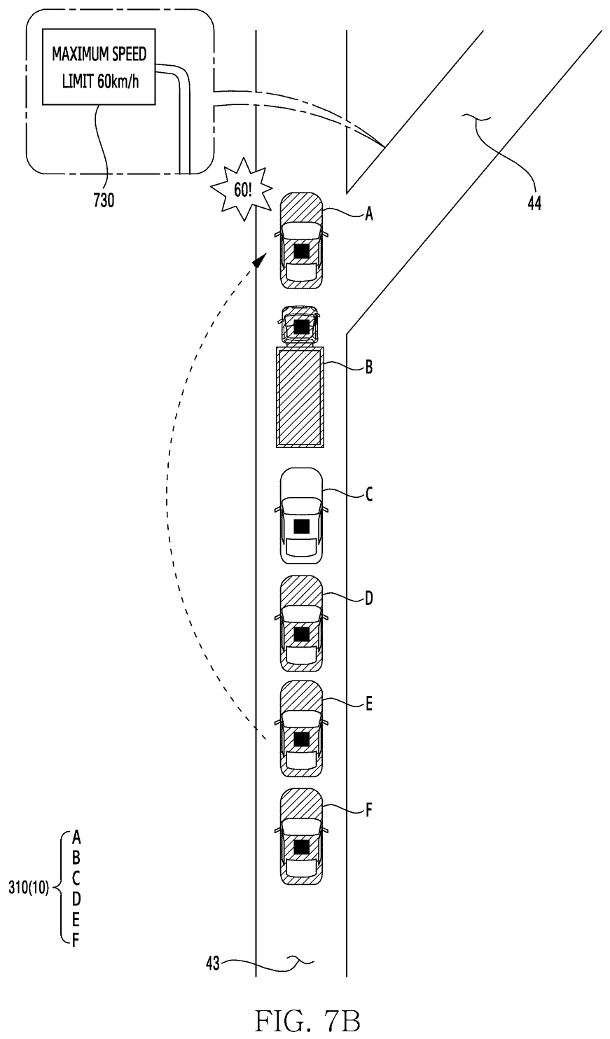

FIGS. 7A and 7B illustrate a formation of vehicles performing platooning according to an embodiment.

FIGS. 7A and 7B illustrate vehicles 10 as time elapses. For example, FIG. 7A illustrates the vehicles 10 at a first timing, and FIG. 7B illustrates the vehicles 10 at a second timing after the first timing.

Referring to FIG. 7A, a distance to a branch point of a vehicle A may be 5 km. For example, a distance to a branch point of a vehicle B may be 3 km. For example, a distance to a branch point of a vehicle C may be 3 km. For example, a distance to a branch point of a vehicle D may be 0.3 km. For example, a distance to a branch point of a vehicle E may be 0.1 km. For example, a distance to a branch point of a vehicle F may be 0.4 km. However, a distance to the branch points of the illustrated vehicles 10 is only for explaining a scenario for controlling the platooning, and the branch points of the vehicles 10 are not limited by the example.

In an embodiment, the vehicle A may control the vehicles 10 in a platoon 310 to travel along a route 710.

In an embodiment, the vehicle A may identify the closest vehicle to the branch point from among the vehicles 10. For example, the vehicle A may identify the closest vehicle E to a branch point 715.

In an embodiment, the vehicle A may confirm whether there is a section including multiple lanes in a route to the branch point of the closest vehicle. In case that there are the multiple lanes, rearrangement operations of the vehicles 10 in the above-described platoon 310 may be performed.

Alternatively, based on confirming that there is no section including the multiple lanes in the route, the vehicle A may determine a safety speed for the closest vehicle to leave the platoon 310 at the branch point. In FIGS. 7A and 7B, since only a lane 43 exists until the branch point 715, the vehicle A may confirm that there is no section including the multiple lanes in the route to the branch point 715 of the closest vehicle E. Accordingly, the vehicle A may determine the safety speed at which the vehicle E leaves the lane 710 at the branch point 715. For example, the vehicle A may determine the safety speed based on a sign 730 that provides speed information on a route 720 after the vehicle E leaves the platoon 310. For example, the vehicle A may receive the information on the safety speed from the vehicle E. For example, the vehicle A may determine the safety speed based on information on a location corresponding to the branch point 715 and/or the route 720 obtained through map data.

In an embodiment, the vehicle A may control the vehicles 10 in the platoon 310 to travel at the safe speed until the vehicle E leaves the route 710.

In an embodiment, the vehicle A may control the vehicles 10 to normally travel in the platoon after the vehicle E moves to the route 720 along a branch lane 44 of the lane 43.

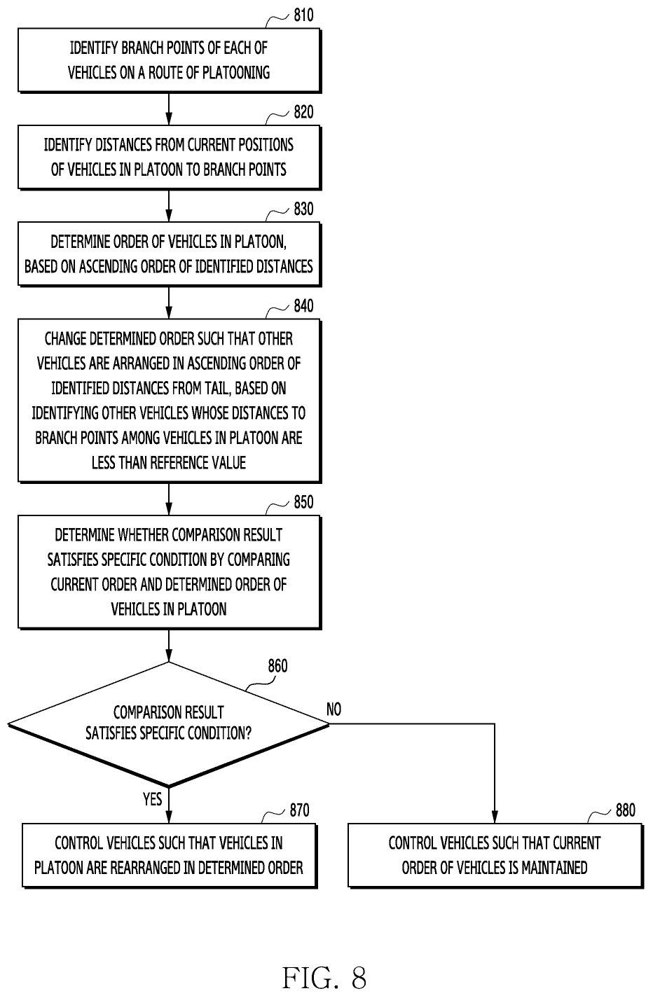

FIG. 8 is a flowchart of an electronic device according to an embodiment.

Operations described with reference to the following drawings may be performed by an electronic device 100 and/or a processor 110. Each operation of FIG. 8 may be performed sequentially, but is not necessarily performed sequentially. For example, an order of each operation may be changed, and at least two operations may be performed in parallel.

Referring to FIG. 8, in operation 810, the electronic device 100 may identify branch points of each of vehicles 10 on a route of platooning.

In operation 820, the electronic device 100 may identify distances from current positions of the vehicles 10 in a platoon 310 to the branch points.

In operation 830, the electronic device 100 may determine an order of the vehicles 10 in the platoon 310, based on an ascending order of the identified distances.

In operation 840, the electronic device 100 may change the determined order such that other vehicles are arranged in the ascending order of the identified distances from a tail based on identifying the other vehicles whose distances to the branch points among the vehicles 10 in the platoon 310 are less than a reference value. The operation of identifying whether the distances to the branch points are less than the reference value may be performed for vehicles that have to leave the platoon 310 for rearrangement among the vehicles 10.

In operation 850, the electronic device 100 may determine whether a comparison result satisfies a specific condition by comparing a current order and the determined order of the vehicles 10 in the platoon 310. For example, in case that a lead vehicle and/or a tail vehicle change before and after the change of the order, the electronic device 100 may determine that the specific condition has been satisfied. In case that there is no change between the lead vehicle and the tail vehicle before and after the change of the order, the electronic device 100 may determine that the specific condition has not been satisfied.

In operation 850, in case that it is determined that the comparison result satisfies the specific condition (operation 860: YES), operation 870 may be performed, otherwise (operation 860: NO), operation 880 may be performed.

In the operation 870, the electronic device 100 may control the vehicles such that the vehicles 10 in the platoon 310 are rearranged in the determined order.

In operation 880, the electronic device 100 may control the vehicles 10 such that the current order of the vehicles 10 is maintained.

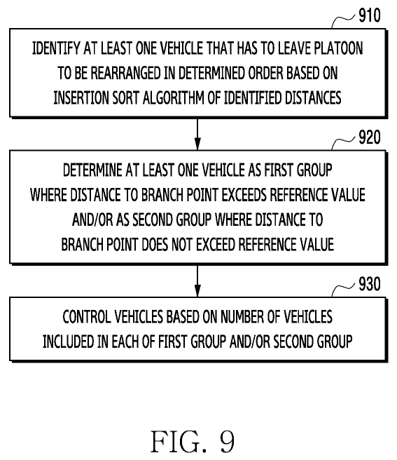

FIG. 9 is a flowchart of an electronic device according to an embodiment.

Each operation of FIG. 9 may be sequentially performed, but is not necessarily performed sequentially. For example, an order of each operation may be changed, and at least two operations may be performed in parallel.

Referring to FIG. 9, in operation 910, an electronic device 100 may identify at least one vehicle that has to leave a platoon 310 to be rearranged in a determined order based on an insertion sort algorithm of identified distances. Additionally, the operation 910 may be performed to determine a target vehicle for determining whether the distances to the branch point in the operation 840 of FIG. 8 are less than a reference value.

In operation 920, the electronic device 100 may determine the at least one vehicle (e.g., a vehicle that needs to leave the platoon 310) as a first group where a distance to a branch point exceeds the reference value (e.g., 1 km) and/or as a second group where a distance to the branch point does not exceed the reference value.

In operation 930, the electronic device 100 may control vehicles 10 based on the number of vehicles included in each of the first group and/or the second group.

For example, in case that the first group includes a first plurality of vehicles, the electronic device 100 may control the vehicles 10 such that the first plurality of vehicles form a sub-platoon on another lane different from a lane in which the platoon 310 is traveling and subsequently merge at a head of the platoon 310. For example, in case that the first group includes only one vehicle, the electronic device 100 may control the vehicles 10, such that the one vehicle leaves the lane in which the platoon 310 is traveling, and subsequently merges at the head of the platoon 310. For example, in case that the second group includes a second plurality of vehicles, the electronic device 100 may control the vehicles 10 such that the second plurality of vehicles form a sub-platoon in the other lane different from the lane in which the platoon 310 is traveling, and subsequently merge at a tail of the platoon 310. For example, in case that the second group includes only one vehicle, the electronic device 100 may control the vehicles 10 such that the one vehicle leaves the lane in which the platoon 310 is traveling, and subsequently merges at the head of the platoon 310.

For example, in case that the first group includes a third plurality of vehicles exceeding a reference number, the electronic device 100 may identify a first specific vehicle having the largest distance to the branch point among the third plurality of vehicles. The electronic device 100 may control the vehicles 10 such that the first specific vehicle maintains the platooning, and control the vehicles 10 such that remaining vehicles form a sub-platoon in the other lane and subsequently merge at the head of the platoon 310. For example, in case that the second group includes a fourth plurality of vehicles exceeding the reference number, the electronic device 100 may identify a second specific vehicle having the largest distance to the branch point among the fourth plurality of vehicles. The electronic device 100 may control vehicles such that the second specific vehicle maintains the platooning in the lane, and may control the vehicles 10 such that remaining vehicles form a sub-platoon in the other lane and subsequently merge at the tail of the platoon.

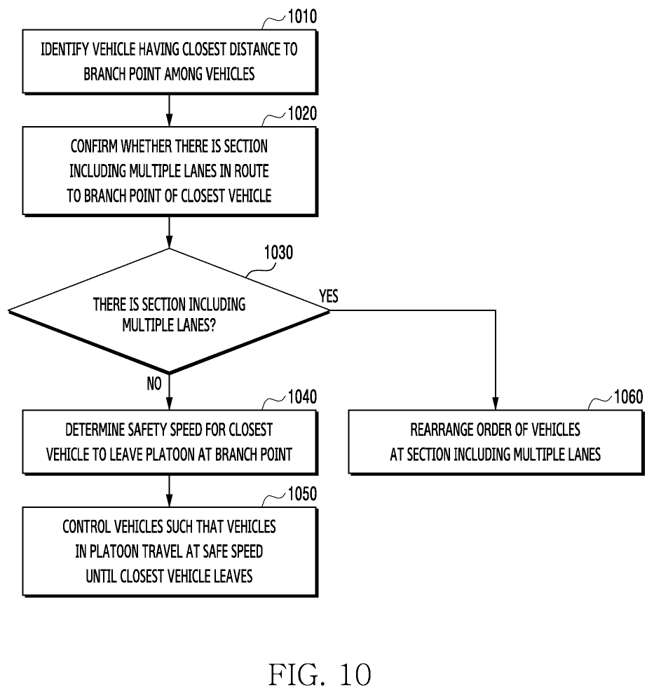

FIG. 10 is a flowchart of an electronic device according to an embodiment.

Each operation of FIG. 10 may be performed sequentially, but is not necessarily performed sequentially. For example, an order of each operation may be changed, and at least two operations may be performed in parallel.

Referring to FIG. 10, in operation 1010, an electronic device 100 may identify a vehicle having the closest distance to a branch point among vehicles 10.

In operation 1020, the electronic device 100 may confirm whether there is a section including multiple lanes in a route to the branch point of the closest vehicle.

As a result of a determination of the operation 1020, in case that there is the section including the multiple lanes (operation 1030: YES), operation 1060 may be performed, and otherwise (operation 1030: NO), operation 1040 may be performed.

In the operation 1040, the electronic device 100 may determine a safety speed for the closest vehicle to leave a platoon 310 at the branch point.

In operation 1050, the electronic device 100 may control the vehicles 10 such that the vehicles in the platoon 310 travel at the safe speed until the closest vehicle leaves.

In operation 1060, the electronic device 100 may rearrange an order of the vehicles at the section including the multiple lanes.

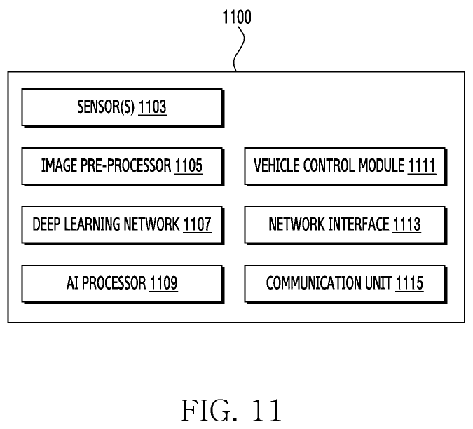

FIG. 11 illustrates an example of a block diagram illustrating an autonomous driving system of a vehicle according to an embodiment.

The autonomous driving system 1100 of the vehicle according to FIG. 11 may be a deep learning network including sensors 1103, an image pre-processor 1105, a deep learning network 1107, an artificial intelligence (AI) processor 1109, a vehicle control module 1111, a network interface 1113, and a communication unit 1115. In various embodiments, each element may be connected through various interfaces. For example, sensor data sensed and outputted by the sensors 1103 may be fed to the image pre-processor 1105. The sensor data processed by the image pre-processor 1105 may be fed to the deep learning network 1107 running on the AI processor 1109. An output of the deep learning network 1107 running by the AI processor 1109 may be fed to the vehicle control module 1111. Intermediate results of the deep learning network 1107 running on the AI processor 1109 may be fed to the AI processor 1109. In various embodiments, the network interface 1113 delivers autonomous driving route information and/or autonomous driving control commands for autonomous driving of the vehicle to internal block configurations, by performing communication with an electronic device (e.g., the electronic device 100 and/or the other electronic devices 200 of FIG. 2) in the vehicle. In an embodiment, the network interface 1113 may be used to transmit the sensor data obtained through the sensor(s) 1103 to an external server. In some embodiments, the autonomous driving control system 1100 may include additional or fewer components as appropriate. For example, in some embodiments, the image pre-processor 1105 may be an optional component. For another example, a post-processing component (not illustrated) may be included in the autonomous driving control system 1100 to perform post-processing on the output of the deep learning network 1107 before the output is provided to the vehicle control module 1111.

In some embodiments, the sensors 1103 may include one or more sensors. In various embodiments, the sensors 1103 may be attached to different locations of the vehicle. The sensors 1103 may face one or more different directions. For example, the sensors 1103 may be attached to a front, sides, a rear, and/or a roof of the vehicle to face directions such as forward-facing, rear-facing, and side-facing. In some embodiments, the sensors 1103 may be image sensors such as high dynamic range cameras. In some embodiments, the sensors 1103 include non-visual sensors. In some embodiments, the sensors 1103 include RADAR, Light Detection And Ranging (LiDAR), and/or ultrasonic sensors in addition to an image sensor. In some embodiments, the sensors 1103 are not mounted on a vehicle having the vehicle control module 1111. For example, the sensors 1103 may be included as a portion of a deep learning system for capturing the sensor data and may be attached to an environment or a roadway and/or mounted on nearby vehicles.

In some embodiments, the image pre-processor 1105 may be used to pre-process the sensor data of the sensors 1103. For example, the image pre-processor 1105 may be used to preprocess the sensor data, to split the sensor data into one or more components, and/or to post-process one or more components. In some embodiments, the image pre-processor 1105 may be a graphics processing unit (GPU), a central processing unit (CPU), an image signal processor, or a specialized image processor. In various embodiments, the image pre-processor 1105 may be a tone-mapper processor for processing high dynamic range data. In some embodiments, the image pre-processor 1105 may be a component of the AI processor 1109.

In some embodiments, the deep learning network 1107 may be a deep learning network for implementing control commands for controlling an autonomous vehicle. For example, the deep learning network 1107 may be an artificial neural network such as a convolution neural network (CNN) trained by using the sensor data, and the output of the deep learning network 1107 is provided to the vehicle control module 1111.

In some embodiments, the artificial intelligence (AI) processor 1109 may be a hardware processor for running the deep learning network 1107. In some embodiments, the AI processor 1109 is a specialized AI processor for performing inference on the sensor data through the convolution neural network (CNN). In some embodiments, the AI processor 1109 may be optimized for a bit depth of the sensor data. In some embodiments, the AI processor 1109 may be optimized for deep learning computations, such as computations of a neural network including a convolution, a dot product, a vector and/or matrix computations. In some embodiments, the AI processor 1109 may be implemented through a plurality of graphics processing units (GPUs) capable of effectively performing parallel processing.

In various embodiments, the AI processor 1109 may be coupled, through an input/output interface, to memory configured to perform a deep learning analysis on the sensor data received from the sensor(s) 1103 while the AI processor 1109 is running and to provide an AI processor having commands that cause to determine a machine learning result used to operate the vehicle at least partially autonomously. In some embodiments, the vehicle control module 1111 may be used to process commands for vehicle control outputted from the artificial intelligence (AI) processor 1109 and translate the output of the AI processor 1109 into commands for controlling a module of each vehicle to control various modules of the vehicle. In some embodiments, the vehicle control module 1111 is used to control a vehicle for autonomous driving. In some embodiments, the vehicle control module 1111 may adjust steering and/or speed of the vehicle. For example, the vehicle control module 1111 may be used to control traveling of the vehicle such as deceleration, acceleration, steering, lane change, lane keeping, and the like. In some embodiments, the vehicle control module 1111 may generate control signals for controlling vehicle lighting, such as brake lights, turns signals, headlights, and the like. In some embodiments, the vehicle control module 1111 may be used to control vehicle audio-related systems such as a vehicle's sound system, vehicle's audio warnings, a vehicle's microphone system, a vehicle's horn system, and the like.

In some embodiments, the vehicle control module 1111 may be used to control notification systems, including warning systems to notify passengers and/or a driver of driving events, such as approach of an intended destination or a potential collision. In some embodiments, the vehicle control module 1111 may be used to adjust sensors, such as the sensors 1103 of the vehicle. For example, the vehicle control module 1111 may modify the orientation of the sensors 1103, change output resolution and/or a format type of the sensors 1103, increase or decrease a capture rate, adjust a dynamic range, and adjust a focus of the camera. In addition, the vehicle control module 1111 may turn on/off the operation of sensors individually or collectively.

In some embodiments, the vehicle control module 1111 may be used to change parameters of the image pre-processor 1105 in a method such as modifying a frequency range of filters, adjusting features and/or edge detection parameters for object detection, or adjusting channels and a bit depth, and the like. In various embodiments, the vehicle control module 1111 may be used to control autonomous driving of the vehicle and/or a driver assistance function of the vehicle.

In some embodiments, the network interface 1113 may be responsible for an internal interface between block configurations of the autonomous driving control system 1100 and the communication unit 1115. Specifically, the network interface 1113 may be a communication interface for receiving and/or transmitting data including voice data. According to various embodiments, the network interface 1113 may be connected to external servers to connect voice calls, receive and/or transmit text messages, transmit sensor data, update software of the vehicle with the autonomous driving system, or update software of the autonomous driving system of the vehicle, through the communication unit 1115.

In various embodiments, the communication unit 1115 may include various wireless interfaces of cellular or WiFi methods. For example, the network interface 1113 may be used to receive an update on operating parameters and/or commands for the sensors 1103, the image pre-processor 1105, the deep learning network 1107, the AI processor 1109, and the vehicle control module 1111 from an external server connected through the communication unit 1115. For example, a machine learning model of the deep learning network 1107 may be updated by using the communication unit 1115. According to another example, the communication unit 1115 may be used to update operating parameters of the image pre-processor 1105, such as image processing parameters, and/or firmware of the sensors 1103.

In another embodiment, the communication unit 1115 may be used to activate communications for an emergency contact and emergency services in an accident or near-accident event. For example, in a crash event, the communication unit 1115 may be used to call emergency services for assistance and may be used to externally notify emergency services of crash details and a location of the vehicle. In various embodiments, the communication unit 1115 may update or obtain an expected arrival time and/or a destination location.

According to an embodiment, the autonomous driving system 1100 illustrated in FIG. 11 may be configured with an electronic device 100 of the vehicle. According to an embodiment, when an autonomous driving release event occurs from a user during autonomous driving of the vehicle, the AI processor 1109 of the autonomous driving system 1100 may control the software of the vehicle autonomous driving to learn by controlling information related to the autonomous driving release event to be inputted as training set data of the deep learning network.

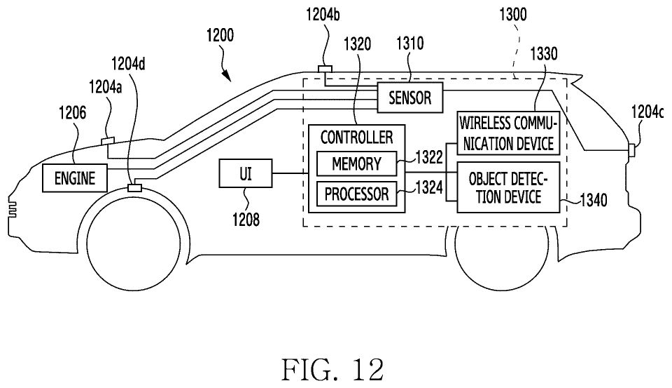

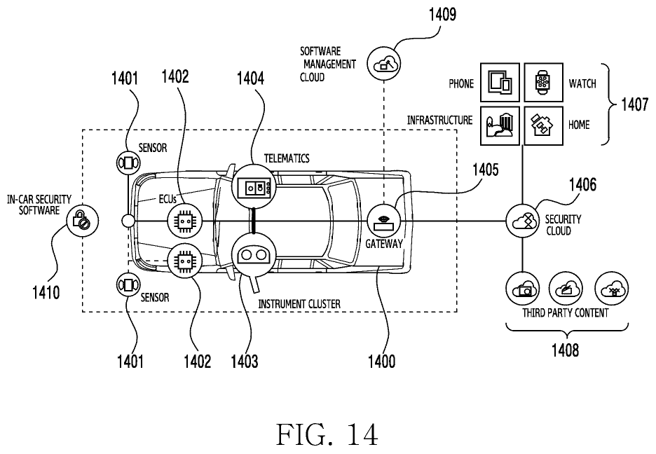

FIGS. 12 and 13 illustrate an example of a block diagram indicating an autonomous driving moving object according to an embodiment. FIG. 14 illustrates an example of a gateway related to a user device according to various embodiments.

Referring to FIG. 12, an autonomous moving object 1200 according to the present embodiment may include a control device 1300, sensing modules 1204a, 1204b, 1204c, and 1204d, an engine 1206, and a user interface 1208.

The autonomous driving moving object 1200 may have an autonomous driving mode or a manual mode. As an example, according to a user input received through the user interface 1208, it may be switched from the manual mode to the autonomous driving mode or may be switched from the autonomous driving mode to the manual mode.

In case that the moving object 1200 operates in the autonomous driving mode, the autonomous driving moving object 1200 may operate under control of the control device 1300.

In the present embodiment, the control device 1300 may include a controller 1320, including memory 1322 and a processor 1324, a sensor 1310, a communication device 1330, and an object detection device 1340.

Herein, the object detection device 1340 may perform all or a portion of a function of a distance measurement device.

That is, in the present embodiment, the object detection device 1340 is a device for detecting an object located outside the moving object 1200, and the object detection device 1340 may detect the object located outside the moving object 1200 and generate object information according to the detection result.

The object information may include information on existence or nonexistence of the object, location information of the object, distance information between the moving object and the object, and relative speed information between the moving object and the object.

The object may include various objects located outside the moving object 1200, such as a lane, another vehicle, a pedestrian, a traffic signal, light, a road, a structure, a speed bump, a landform, an animal, and the like. Herein, the traffic signal may be a concept including a traffic signal, a traffic sign, a pattern or text drawn on a road surface. In addition, the light may be light generated from a lamp equipped in another vehicle, light generated from a streetlamp, or sunlight.

In addition, the structure may be an object located around a road and fixed to the ground. For example, the structure may include a streetlamp, a street tree, a building, a power pole, a traffic light, and a bridge. The landform may include a mountain, a hill, and the like.

Such the object detection device 1340 may include a camera module. The controller 1320 may extract object information from an external image photographed by the camera module and enable the controller 1320 to process information thereon.

In addition, the object detection device 1340 may further include imaging devices for recognizing an external environment. RADAR, a GPS device, Odometry, and another computer vision device, an ultrasonic sensor, and an infrared sensor may be used, in addition to LIDAR, and these devices may be selected or operated simultaneously as needed to enable more precise detection.

Meanwhile, the distance measurement device according to an embodiment of the present invention may calculate a distance between the autonomous driving moving object 1200 and the object, and may control an operation of the moving object based on the distance calculated in connection with the control device 1300 of the autonomous driving moving object 1200.

As an example, in case that there is a probability of a collision according to the distance between the autonomous driving moving object 1200 and the object, the autonomous driving moving object 1200 may control a brake to lower a speed or stop. As another example, in case that the object is a moving object, the autonomous driving moving object 1200 may control a traveling speed of the autonomous driving moving object 1200 to maintain a predetermined distance or more from the object.

This distance measurement device according to an embodiment of the present invention may be configured as a module in the control device 1300 of the autonomous driving moving object 1200. That is, the memory 1322 and the processor 1324 of the control device 1300 may be configured to implement a collision prevention method according to the present invention in software.

In addition, the sensor 1310 may obtain various sensing information by connecting an internal/external environment of the moving object with the sensing modules 1204a, 1204b, 1204c, and 1204d. Herein, the sensor 1310 may include a posture sensor, a yaw sensor, a roll sensor, a pitch sensor, a collision sensor, a wheel sensor, a speed sensor, a tilt sensor, a weight detection sensor, a heading sensor, a gyro sensor, a position module, a moving object forward/rearward sensor, a battery sensor, a fuel sensor, a tire sensor, a steering sensor by handle rotation, a moving object internal temperature sensor, a moving object internal humidity sensor, an ultrasonic sensor, an illumination sensor, an accelerator pedal position sensor, a brake pedal position sensor, and the like.

Accordingly, the sensor 1310 may obtain sensing signals for moving object posture information, moving object collision information, moving object direction information, moving object location information (GPS information), moving object angle information, moving object speed information, moving object acceleration information, moving object tilt information, moving object forward/rearward information, battery information, fuel information, tire information, moving object lamp information, and moving object internal temperature information, moving object internal humidity information, a steering wheel rotation angle, moving object external illumination, a pressure applied to an accelerator pedal, a pressure applied to a brake pedal, and the like.

In addition, the sensor 1310 may further include an accelerator pedal sensor, a pressure sensor, an engine speed sensor, an air flow sensor (AFS), an intake air temperature sensor (ATS), a water temperature sensor (WTS), a throttle position sensor (TPS), a TDC sensor, a crank angle sensor (CAS), and the like.

As such, the sensor 1310 may generate moving object state information based on sensing data.

The wireless communication device 1330 is configured to implement wireless communication between the autonomous driving moving object 1200. For example, The wireless communication device 1330 enables the autonomous driving moving object 1200 to communicate with a mobile phone of a user, or the other wireless communication device 1330, another moving object, a central device (a traffic control device), a server, and the like. The wireless communication device 1330 may transmit and receive a wireless signal according to an access wireless protocol. A wireless communication protocol may be Wi-Fi, Bluetooth, Long-Term Evolution (LTE), Code Division Multiple Access (CDMA), Wideband Code Division Multiple Access (WCDMA), Global Systems for Mobile Communications (GSM), but the communication protocol is not limited thereto.

In addition, in the present embodiment, it is also possible for the autonomous driving moving object 1200 to implement communication between moving objects through the wireless communication device 1330. That is, the wireless communication device 1330 may perform communication with another moving object and other moving objects on the road through vehicle-to-vehicle (V2V) communication. The autonomous driving moving object 1200 may transmit and receive information such as driving warning and traffic information through the vehicle-to-vehicle (V2V) communication, and it is also possible to request information from, or receive a request from the other moving object. For example, the wireless communication device 1330 may perform the V2V communication as a dedicated short-range communication (DSRC) device or a Cellular-V2V (C-V2V) device. In addition, besides the vehicle-to-vehicle (V2V) communication, communication (e.g., Vehicle to Everything communication (V2X)) between a vehicle and another object (e.g., an electronic device carried by a pedestrian, and the like) may also be implemented through the wireless communication device 1330.

In addition, the wireless communication device 1330 may obtain information generated from various mobilities, including infrastructure (a traffic light, a CCTV, a RSU, a eNode B, and the like) located on the road or other autonomous driving/non-autonomous driving vehicles, and the like, through a non-terrestrial network other than a terrestrial network, as information for autonomous driving performance of the autonomous driving moving object 1200.

For example, the wireless communication device 1330 may perform wireless communication through a Low Earth Orbit (LEO) satellite system, a Medium Earth Orbit (MEO) satellite system, a Geostationary Orbit (GEO) satellite system, a High Altitude Platform (HAP) system, and the like, that configure a non-terrestrial network and an antenna dedicated to the non-terrestrial network mounted on the autonomous driving moving object 1200.

For example, the wireless communication device 1330 may perform wireless communication with various platforms configuring the NTN according to a 5TH Generation New Radio Non-Terrestrial Network (5G NR NTN) standard, which is currently discussed in 3GPP, and the like, but is not limited thereto.

In the present embodiment, the controller 1320 may select a platform that may properly perform NTN communication in consideration of various information such as a location of the autonomous driving moving object 1200, current time, and available power, and control the wireless communication device 1330 to perform wireless communication with the selected platform.

In the present embodiment, the controller 1320, which is a unit that controls an overall operation of each unit in the moving object 1200, may be configured by a manufacturer of the moving object when manufacturing or may be additionally configured to perform a function of autonomous driving after manufacturing. In addition, a configuration for performing a continuous additional function may be included through an upgrade of the controller 1320 configured when manufacturing. This controller 1320 may also be named an Electronic Control Unit (ECU).

The controller 1320 may collect various data from the connected sensor 1310, the object detection device 1340, the communication device 1330, and may transmit a control signal to the sensor 1310, the engine 1206, the user interface 1208, the communication device 1330, and the object detection device 1340 included in other components in the moving object based on the collected data. In addition, although not illustrated, the control signal may also be transmitted to an acceleration device, a braking system, a steering device, or a navigation device related to traveling of the moving object.

In the present embodiment, the controller 1320 may control the engine 1206, for example, may detects a speed limit of a road on which the autonomous driving moving object 1200 is traveling, and may control the engine 1206 so that a traveling speed does not exceed the speed limit or may control the engine 1206 to accelerate the traveling speed of the autonomous driving moving object 1200 in a range that does not exceed the speed limit.

In addition, when the autonomous driving moving object 1200 approaches a lane or leaves the lane while the autonomous driving moving object 1200 is traveling, the controller 1320 may determine whether such lane approaching and leaving are due to a normal traveling situation or another traveling situation, and may control the engine 1206 to control the traveling of the moving object according to the determination result. Specifically, the autonomous driving moving object 1200 may detect lanes formed on both sides of the lane in which the moving object is traveling. In this case, the controller 1320 may determine whether the autonomous driving moving object 1200 approaches the lane or leaves the lane, and if it is determined that the autonomous driving moving object 1200 approaches the lane or leaves the lane, the controller 1320 may determine whether this traveling is according to an accurate traveling situation or another traveling situation. Herein, as an example of the normal traveling situation, it may be a situation in which a lane change of the moving object is required. In addition, as an example of the other driving situations, it may be a situation in which a lane change of the moving object is not required. When it is determined that the autonomous driving moving object 1200 is approaching the lane or leaving the lane in a situation in which the moving object does not need to change lane, the controller 1320 may control the traveling of the autonomous driving moving object 1200 so that the autonomous driving moving object 1200 does not leave the lane and normally travels in a corresponding vehicle.

In case that another moving object or an obstacle exists in a front of the moving object, it may control the engine 1206 or the braking system to decelerate the driving moving object, and may control a trajectory, a traveling route, and a steering angle in addition to speed. Alternatively, the controller 1320 may control the traveling of the moving object by generating a necessary control signal according to recognition information of another external environment, such as a traveling lane or a driving signal of the moving object.

In addition to generating its own control signal, the controller 1320 may also control the traveling of the moving object by performing communication with a nearby moving object or a central server and transmitting a command to control peripheral devices through the received information.

In addition, since accurate recognition of the moving object or lane according to the present embodiment may be difficult in case that a location of the camera module 1350 changes or an angle of view changes, the controller 1320 may generate a control signal for controlling to perform calibration of the camera module 1350 to prevent this. Therefore, in the present embodiment, by generating the calibration control signal to the camera module 1350, the controller 1320 may continuously maintain a normal mounting location, a direction, an angle of view, and the like of the camera module 1350 even when a mounting location of the camera module 1350 is changed due to vibration or impact generated by a movement of the autonomous driving moving object 1200. In case that an initial mounting location, a direction, and an angle of view information of the camera module 1350 that are pre-stored, and an initial mounting location, a direction, an angle of view information, and the like of the camera module 1350 measured while the autonomous driving moving object 800 is traveling are changed by a threshold value or more, the controller 1320 may generate the control signal to perform the calibration of the camera module 1350.

In the present embodiment, the controller 1320 may include the memory 1322 and the processor 1324. The processor 1324 may execute software stored in the memory 1322 according to the control signal of the controller 1320. Specifically, the controller 1320 may store data and commands for performing the lane detection method according to the present invention in the memory 1322, and the commands may be executed by the processor 1324 to implement one or more methods disclosed herein.

In this case, the memory 1322 may be stored in a recording medium executable by the non-volatile processor 1324. The memory 1322 may store software and data through an appropriate internal/external device. The memory 1322 may be configured with random access memory (RAM), read only memory (ROM), a hard disk, and a memory 1322 device connected with a dongle.

The memory 1322 may at least store an Operating system (OS), a user application, and executable commands. The memory 1322 may also store application data and array data structures.

The processor 1324, which is a microprocessor or an appropriate electronic processor, may be a controller, a microcontroller, or a state machine.

The processor 1324 may be implemented as a combination of computing devices, and the computing device may be configured with a digital signal processor, a microprocessor, or an appropriate combination thereof.

Meanwhile, the autonomous driving moving object 1200 may further include the user interface 1208 for a user input with respect to the above-described control device 1300. The user interface 1208 may enable a user to input information with appropriate interaction. For example, it may be implemented as a touch screen, a keypad, or an operation button, and the like. The user interface 1208 may transmit an input or a command to the controller 1320, and the controller 1320 may perform a control operation of the moving object in response to the input or the command.

In addition, the user interface 1208, which is a device outside the autonomous driving moving object 1200, may perform communication with the autonomous driving moving object 1200 through the wireless communication device 1330. For example, the user interface 808 may be linkable with a mobile phone, a tablet, or another computer device.

Furthermore, in the present embodiment, the autonomous driving moving object 1200 has been described as including the engine 1206, but it may also include another type of a propulsion system. For example, the moving object may be operated with electrical energy, and may be operated through hydrogen energy or a hybrid system combining them. Therefore, the controller 1320 may include a propulsion mechanism according to the propulsion system of the autonomous driving moving object 1200 and may provide a control signal according to this to components of each propulsion mechanism.

Hereinafter, a detailed configuration of the control device 1300 according to the present invention according to the present embodiment will be described in more detail with reference to FIG. 14.

A control device 1300 includes a processor 1324. The processor 1324 may be a general-purpose single or multi-chip microprocessor, a dedicated microprocessor, a microcontroller, a programmable gate array, and the like. The processor may be referred to as a central processing unit (CPU). In addition, in the present embodiment, it is possible that the processor 1324 is used as a combination of a plurality of processors.

The control device 1300 also includes memory 1322. The memory 1322 may be any electronic component capable of storing electronic information. The memory 1322 may also include a combination of the memories 1322 in addition to single memory.

Data and commands 1322a for performing a distance measuring method of a distance measuring device according to the present invention may be stored in the memory 1322. When the processor 1324 executes the commands 1322a, all or a portion of the commands 1322a and the data 1322b required for performing a command may be loaded 1324a and 1324b onto the processor 1324.

The control device 1300 may include a transmitter 1330a, a receiver 1330b, or a transceiver 1330c for permitting transmission and reception of signals. One or more antennas 1332a and 1332b may be electrically connected to the transmitter 1330a, the receiver 1330b, or each transceiver 1330c, and may further include antennas.

The control device 1300 may include a digital signal processor (DSP) 1370. Through the DSP 1370, the digital signal may be quickly processed by a moving object.

The control device 1300 may include a communication interface 1380. The communication interface 1380 may include one or more ports and/or communication modules for connecting other devices to the control device 1300. The communication interface 1380 may enable a user and the control device 1300 to interact with each other.

Various configurations of the control device 1300 may be connected together by one or more buses 1390, and the buses 1390 may include a power bus, a control signal bus, a state signal bus, a data bus, and the like. Under a control of the processor 1324, configurations may transmit mutual information through the bus 1390 and perform a desired function.

Meanwhile, in various embodiments, the control device 1300 may be related to a gateway for communication with a security cloud. For example, referring to FIG. 14, the control device 1300 may be related to a gateway 1405 for providing information obtained from at least one of components 1001 to 1004 of a vehicle 1400 to a security cloud 1406. For example, the gateway 1405 may be included in the control device 1300. For another example, the gateway 1405 may be configured as a separate device in the vehicle 1400 that is distinguished from the control device 1300. The gateway 1405 connects a network in the vehicle 1400 secured by a software management cloud 1409, the security cloud 1406, and in-car security software 1410, having different networks, to enable communication.

For example, a component 1401 may be a sensor. For example, the sensor may be used to obtain information on at least one of a state of the vehicle 1400 or a state around the vehicle 1400. For example, the component 1401 may include a sensor 1310.

For example, a component 1402 may be electronic control units (ECUs). For example, the ECUs may be used for engine control, transmission control, airbag control, and tire pressure management.

For example, a component 1403 may be an instrument cluster. For example, the instrument cluster may mean a panel located in a front of a driver's seat among dashboards. For example, the instrument cluster may be configured to display information necessary for driving to a driver (or a passenger). For example, the instrument cluster may be used to display at least one of visual elements for indicating a revolutions per minute (or rotates per minute) (RPM) of the engine, visual elements for indicating a speed of the vehicle 1400, visual elements for indicating an amount of remaining fuel, visual elements for indicating a state of a gear, or visual elements for indicating information obtained through the component 1401.

For example, a component 1404 may be a telematics device. For example, the telematics device may mean a device that provides various mobile communication services, such as location information and safe driving in the vehicle 1400 by coupling wireless communication technology and global positioning system (GPS) technology. For example, the telematics device may be used to connect the vehicle 1400 with a driver, a cloud (e.g., the security cloud 1406), and/or a surrounding environment. For example, the telematics device may be configured to support high bandwidth and low latency for 5G NR-standard technology (e.g., V2X technology of the 5G NR, Non-Terrestrial Network (NTN) technology of the 5G NR). For example, the telematics device may be configured to support autonomous driving of the vehicle 1400.

For example, the gateway 1405 may be used to connect a network within the vehicle 1400, and the software management cloud 1409 and the secure cloud 1406, which are a network outside the vehicle. For example, the software management cloud 1409 may be used to update or manage at least one software necessary for traveling and managing the vehicle 1400. For example, the software management cloud 1409 may be linked to the in-car security software 1410 installed in the vehicle. For example, the in-car security software 1410 may be used to provide a security function in the vehicle 1400. For example, the in-car security software 1410 may encrypt data transmitted and received through an in-car network using an encryption key obtained from an external authorized server for encryption of the in-car network. In various embodiments, the encryption key used by the in-car security software 1410 may be generated corresponding to vehicle identification information (a vehicle license plate, a vehicle identification number (VIN)) or information (e.g., user identification information) uniquely assigned to each user.

In various embodiments, the gateway 1405 may transmit the data encrypted by the in-car security software 1410 based on the encryption key to the software management cloud 1409 and/or the security cloud 1406. The software management cloud 1409 and/or the security cloud 1406 may identify the data received from which vehicle or which user by decrypting the data encrypted by the encryption key of the in-car security software 1410. For example, since the decryption key is a unique key corresponding to the encryption key, the software management cloud 1409 and/or the security cloud 1406 may identify a transmission entity (e.g., the vehicle or the user) of the data based on the data decrypted through the decryption key.

For example, the gateway 1405 may be configured to support in-car security software 1410 and may be related to the control device 1300. For example, the gateway 1405 may be related to the control device 1300 to support a connection between a client device 1407 and the control device 1300 connected to the security cloud 1406. For another example, the gateway 1405 may be related to the control device 1300 to support a connection between a third-party cloud 1408 connected to the security cloud 1406 and the control device 1300. However, it is not limited thereto.

In various embodiments, the gateway 1405 may be used to connect the vehicle 1400 with the software management cloud 1409 to manage operating software of the vehicle 1400. For example, the software management cloud 1409 may monitor whether updating the operating software of the vehicle 1400 is required, and based on monitoring that the updating the operating software of the vehicle 1400 is required, provide data for the updating the operating software of the vehicle 1400 through the gateway 1405. For another example, the software management cloud 1409 may receive a user request for updating the operating software of the vehicle 1400 from the vehicle 1400 through the gateway 1405, and provide data for updating the operating software of the vehicle 1400 based on the reception. However, it is not limited thereto.

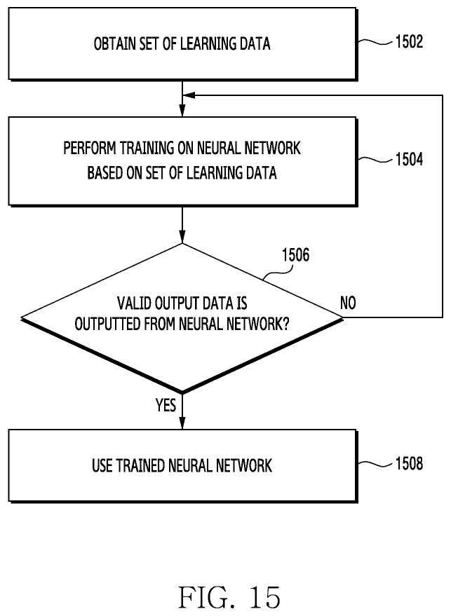

FIG. 15 is a diagram for explaining an operation of an electronic device for training a neural network based on a set of learning data, according to an embodiment.

An operation described with reference to FIG. 15 may be performed by the above-described electronic device (e.g., the electronic device 100 of FIG. 2).

Referring to FIG. 15, in operation 1502, the electronic device may obtain the set of the learning data according to an embodiment. The electronic device may obtain the set of the learning data for supervised learning. The learning data may include a pair of input data and ground truth data corresponding to the input data. The ground truth data may indicate output data to be obtained from the neural network that has received the input data, which is the pair of the ground truth data. The ground truth data may be obtained by the electronic device described above.

For example, in case of training the neural network for image recognition, the learning data may include information regarding an image and one or more subjects included within the image. The information may include a category (or a class) of a subject identifiable through the image. The information may include a location, a width, a height, and/or a size of a visual object corresponding to the subject within the image. The set of the learning data identified through the operation 1502 may include pairs of a plurality of learning data. In the example of training the neural network for the image recognition, the set of the learning data identified by the electronic device may include a plurality of images and ground truth data corresponding to each of the plurality of images.

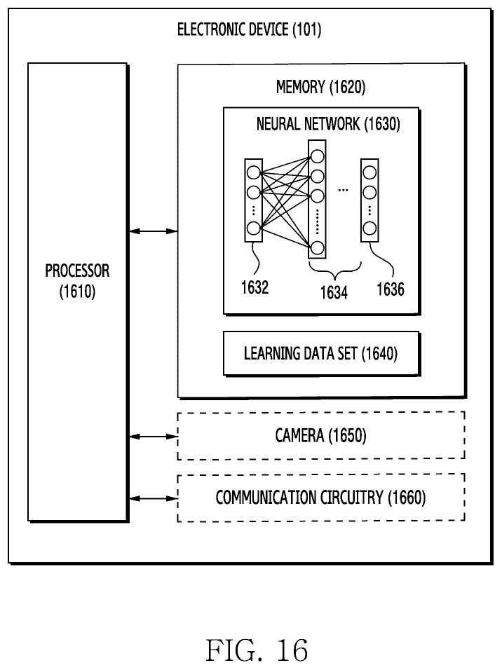

Referring to FIG. 15, in operation 1504, the electronic device according to an embodiment may perform training on the neural network based on the set of the learning data. In an embodiment in which the neural network is trained based on the supervised learning, the electronic device may input the input data included in the learning data to an input layer of the neural network. An example of the neural network including the input layer will be described with reference to FIG. 16. From an output layer of the neural network receiving the input data through the input layer, the electronic device may obtain output data of the neural network corresponding to the input data.

In an embodiment, the training of the operation 1504 may be performed based on a difference between the output data and the ground truth data included in the learning data and corresponding to the input data. For example, the electronic device may adjust one or more parameters related to the neural network (e.g., a weight to be described later with reference to FIG. 16) to reduce the difference based on a gradient descent algorithm. An operation of the electronic device adjusting the one or more parameters may be referred to as tuning for the neural network. The electronic device may perform the tuning of the neural network based on the output data using a function defined to evaluate performance of the neural network, such as a cost function. The difference between the output data and the ground truth data may be included as an example of the cost function.

Referring to FIG. 15, in operation 1506, according to an embodiment, the electronic device may identify whether valid output data is outputted from the neural network trained by the operation 1504. The output data being valid may mean that the difference (or the cost function) between the output data and the ground truth data satisfies a condition set for use of the neural network. For example, in case that an average value and/or the maximum value of the difference between the output data and the ground truth data is less than or equal to a designated threshold value, the electronic device may determine that the valid output data is outputted from the neural network.

In case that the valid output data is not outputted from the neural network (1506-NO), the electronic device may repeatedly perform training of the neural network based on the operation 1504. An embodiment is not limited thereto, and the electronic device may repeatedly perform the operations 1502 and 1504.

In a state in which the valid output data is obtained from the neural network (1506-YES), based on operation 1508, the electronic device according to an embodiment may use the trained neural network. For example, the electronic device may input other input data to the neural network that is distinct from the input data inputted to the neural network as the learning data. The electronic device may use output data obtained from the neural network receiving the other input data as a result of performing inference on the other input data based on the neural network.

FIG. 16 is a block diagram of an electronic device according to an embodiment.

An electronic device 100 of FIG. 16 may include the above-described electronic device.

For example, an operation described with reference to FIG. 16 may be performed by the electronic device 100 of FIG. 16 and/or a processor 1610 of FIG. 16.

Referring to FIG. 16, the processor 1610 of the electronic device 100 may perform computations related to a neural network 1630 stored in memory 1620. The processor 1610 may include at least one of a central processing unit (CPU), a graphic processing unit (GPU), and a neural processing unit (NPU). The NPU may be implemented as a chip separated from the CPU, or integrated into a chip such as the CPU in a form of a system on a chip (SoC). The NPU integrated into the CPU may be referred to as a neural core and/or an artificial intelligence (AI) accelerator.

Referring to FIG. 16, the processor 1610 may identify the neural network 1630 stored in the memory 1620. The neural network 1630 may include a combination of an input layer 1632, one or more hidden layers 1634 (or intermediate layers), and an output layer 1636. The above-described layers (e.g., the input layer 1632, the one or more hidden layers 1634, and the output layer 1636) may include a plurality of nodes. The number of hidden layers 1634 may vary according to an embodiment, and the neural network 1630 including the plurality of hidden layers 1634 may be referred to as a deep neural network. An operation of training the deep neural network may be referred to as deep learning.

In an embodiment, in case that the neural network 1630 has a structure of a feed forward neural network, a first node included in a specific layer may be connected to all of second nodes included in another layer before the specific layer. In the memory 1620, parameters stored for the neural network 1630 may include weights assigned to connections between the second nodes and the first node. In the neural network 1630 having the structure of the feed forward neural network, a value of the first node may correspond to a weighted sum of values assigned to the second nodes, based on the weights assigned to the connections connecting the second nodes and the first node.

In an embodiment, in case that the neural network 1630 has a structure of a convolutional neural network, the first node included in the specific layer may correspond to a weighted sum of a portion of the second nodes included in the other layer before the specific layer. The portion of the second nodes corresponding to the first node may be identified by a filter corresponding to the specific layer. In the memory 1620, the parameters stored for the neural network 1630 may include weights indicating the filter. The filter may include, among the second nodes, one or more nodes to be used to calculate a weighted sum of the first node, and weights corresponding to each of the one or more nodes.

According to an embodiment, the processor 1610 of the electronic device 100 may perform training on the neural network 1630 using a learning data set 1640 stored in the memory 1620. Based on the learning data set 1640, the processor 1610 may adjust one or more parameters stored in the memory 1620 for the neural network 1630 by performing the operation described with reference to FIG. 15.

According to an embodiment, the processor 1610 of the electronic device 100 may perform object detection, object recognition, and/or object classification using the neural network 1630 trained based on the learning data set 1640. The processor 1610 may input an image (or a video) obtained through a camera 1650 into the input layer 1632 of the neural network 1630. Based on the input layer 1632 to which the image is inputted, the processor 1610 may obtain a set (e.g., the output data) of values of the nodes of the output layer 1636 by sequentially obtaining values of the nodes of the layers included in the neural network 1630. The output data may be used as a result of inferring information included in the image using the neural network 1630. An embodiment is not limited thereto, and the processor 1610 may input an image (or a video) obtained from an external electronic device connected to the electronic device 100 through communication circuitry 1660 to the neural network 1630.

In an embodiment, the neural network 1630 trained to process an image may be used to identify a region corresponding to a subject within the image (object detection), and/or to identify a class of the subject represented within the image (object recognition and/or object classification). For example, the electronic device 100 may segment the region corresponding to the subject within the image based on a quadrangle shape such as a bounding box, using the neural network 1630. For example, the electronic device 100 may identify at least one class matching the subject among a plurality of designated classes using the neural network 1630.

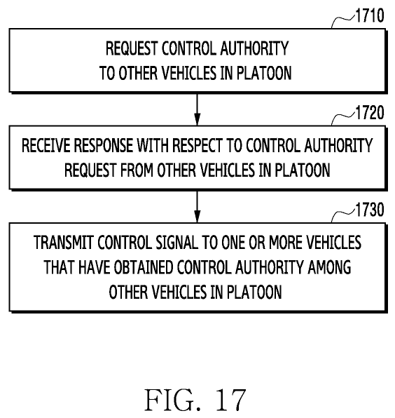

FIG. 17 is a flowchart of an electronic device according to an embodiment. Each operation of FIG. 17 may be sequentially performed, but is not necessarily performed sequentially. For example, an order of each operation may be changed, and at least two operations may be performed in parallel.

Hereinafter, operations in which an electronic device 100 obtains control authority for other vehicles in a platoon 310 and controls the other vehicles in the platoon 310 according to the obtained control authority will be described with reference to FIG. 17.

In operation 1710, the electronic device 100 may request the control authority to the other vehicles in the platoon 310. For example, the electronic device 100 may transmit the request of the control authority to the other vehicles (or their electronic devices) in the platoon 310. The control authority may include, for example, a temporary control authority such as a floor control.

In operation 1720, the electronic device 100 may receive a response with respect to the control authority request from the other vehicles in the platoon 310. For example, the response with respect to the request for the control authority may include a positive Ack or a negative Ack.

In operation 1730, the electronic device 100 may transmit a control signal to one or more vehicles that have obtained the control authority among the other vehicles in the platoon 310. For example, the electronic device 100 may obtain the control authority for one or more vehicles that have transmitted the positive Ack among the other vehicles in the platoon 310. The electronic device 100 may transmit the control signal to the one or more vehicles having the control authority. Accordingly, the operations in which the electronic device 100 controls vehicles 10 in the platoon 310 described above may be performed.

In an embodiment, an electronic device for platooning of vehicles may comprise memory storing instructions and a processor, and the instructions, when executed by the processor, may cause the electronic device to identify branch points for each of the vehicles on a route of the platooning, wherein the branch points are locations where the vehicles leave the platoon, identify distances from current positions of the vehicles to the branch points, determine an order of the vehicles in the platoon based on an ascending order of the identified distances, and based on determining that a lead vehicle in a current order of the vehicles in the platoon is different from a lead vehicle in the determined order and/or determining that a tail vehicle in the current order of the vehicles in the platoon is different from a tail vehicle in the determined order, control the vehicles such that the vehicles in the platoon are rearranged according to the determined order.

In an embodiment, the instructions, when executed by the processor, may cause the electronic device to, based on identifying other vehicles from among the vehicles in which the distances to the branch points are less than a reference value, change the determined order such that the other vehicles are rearranged in the ascending order of the identified distances from the tail.

In an embodiment, the instructions, when executed by the processor, may cause the electronic device to, based on an insertion sort algorithm for the identified distances, identify at least one vehicle that has to leave the platoon to be rearranged according to the determined order, determine the at least one vehicle as a first group, where a distance to the branch point exceeds the reference value, and/or as a second group, where a distance to the branch point does not exceed the reference value, and control, when the first group includes a first plurality of vehicles, the vehicles such that the first plurality of vehicles form a first sub-platoon in another lane different from a lane in which the platoon is traveling and subsequently merge at a head of the platoon.

In an embodiment, the instructions, when executed by the processor, may cause the electronic device to control, when the first group includes only one vehicle, the vehicles such that the one vehicle leaves the lane in which the platoon is traveling and subsequently merges at a head of the platoon.

In an embodiment, the instructions, when executed by the processor, cause the electronic device to control, when the second group includes a second plurality of vehicles, the vehicles such that the second plurality of vehicles form a second sub-platoon in the another lane from the lane in which the platoon is traveling and subsequently merge at a tail of the platoon.

In an embodiment, the instructions, when executed by the processor, may cause the electronic device to control, when the second group includes only one other vehicle, the vehicles such that the one other vehicle leaves the lane in which the platoon is traveling and subsequently merges at a head of the platoon.

In an embodiment, the instructions, when executed by the processor, may cause the electronic device to determine the at least one vehicle as the first group, where the distance to the branch point exceeds the reference value, and/or as the second group, where the distance to the branch point does not exceed the reference value, and when the first group includes a third plurality of vehicles exceeding a reference number, identify a specific vehicle from among the third plurality of vehicles having the largest distance to the branch point, control the vehicles such that the specific vehicle maintains the platooning in the lane, and control the vehicles such that remaining vehicles form a third sub-platoon in the another lane and subsequently merge at a head of the platoon.

In an embodiment, the instructions, when executed by the processor, may cause the electronic device to determine the at least one vehicle as the first group, where a distance to the branch point exceeds the reference value, and/or as the second group, where a distance to the branch point does not exceed the reference value, and when the second group includes a fourth plurality of vehicles exceeding a reference number, identify a specific vehicle from among the fourth plurality of vehicles having the largest distance to the branch point, control the vehicles such that the specific vehicle maintains the platooning in the lane, and control the vehicles such that remaining vehicles to form a fourth sub-platoon in the another lane and subsequently merge at a tail of the platoon.

In an embodiment, the instructions, when executed by the processor, may cause the electronic device to identify the closest vehicle to the branch point from among the vehicles, confirm whether there is a section including multiple lanes in a route to the branch point of the closest vehicle, based on confirming that there is no section including the multiple lanes in the route, determine a safe speed for the closest vehicle to leave the platoon at the branch point of the closest vehicle, and control the vehicles such that the vehicles in the platoon travel at the safe speed until the closest vehicle leaves the platoon.

In an embodiment, the instructions, when executed by the processor, may cause the electronic device to, based on determining that a lead vehicle and a tail vehicle in the current order in the platoon are identical to a lead vehicle and a tail vehicle in the determined order, control the vehicles to maintain the current order of the vehicles.

In an embodiment, the instructions, when executed by the processor, may cause the electronic device to obtain information regarding destinations of the vehicles from each of the vehicles, and identify the branch points based on the information.

In an embodiment, a method performed by an electronic device for platooning of vehicles may comprise identifying branch points for each of the vehicles on a route of the platooning, wherein the branch points are locations where the vehicles leave the platoon, identifying distances from current positions of the vehicles to the branch points, determining an order of the vehicles in the platoon based on an ascending order of the identified distances, and based on determining that a lead vehicle in a current order of the vehicles in the platoon is different from a lead vehicle in the determined order and/or determining that a tail vehicle in the current order of the vehicles in the platoon is different from a tail vehicle in the determined order, controlling the vehicles such that the vehicles in the platoon are rearranged according to the determined order.

In an embodiment, the method may comprise, based on identifying other vehicles from among the vehicles in which the distances to the branch points are less than a reference value, changing the determined order such that the other vehicles are rearranged in the ascending order of the identified distances from the tail.

In an embodiment, the method may comprise, based on an insertion sort algorithm for the identified distances, identifying at least one vehicle that has to leave the platoon to be rearranged according to the determined order, determining the at least one vehicle as a first group, where a distance to the branch point exceeds the reference value, and/or as a second group, where a distance to the branch point does not exceed the reference value, and controlling, when the first group includes a first plurality of vehicles, the vehicles such that the first plurality of vehicles form a first sub-platoon in another lane different from a lane in which the platoon is traveling and subsequently merge at a head of the platoon.

In an embodiment, the method may comprise controlling, when the first group includes only one vehicle, the vehicles such that the one vehicle leaves the lane in which the platoon is traveling and subsequently merges at a head of the platoon.

In an embodiment, the method may comprise controlling, when the second group includes a second plurality of vehicles, the vehicles such that the second plurality of vehicles form a second sub-platoon in the another lane from the lane in which the platoon is traveling and subsequently merge at a tail of the platoon.

In an embodiment, the method may comprise controlling, when the second group includes only one other vehicle, the vehicles, such that the one other vehicle leaves the lane in which the platoon is traveling and subsequently merges at a head of the platoon.

In an embodiment, the method may comprise determining the at least one vehicle as the first group, where the distance to the branch point exceeds the reference value, and/or as the second group, where the distance to the branch point does not exceed the reference value, and when the first group includes a third plurality of vehicles exceeding a reference number, identifying a specific vehicle from among the third plurality of vehicles having the largest distance to the branch point, controlling the vehicles, such that the specific vehicle maintains the platooning in the lane, and controlling the vehicles, such that remaining vehicles form a third sub-platoon in the another lane and subsequently merge at a head of the platoon.

In an embodiment, the method may comprise determining the at least one vehicle as the first group, where a distance to the branch point exceeds the reference value, and/or as the second group, where a distance to the branch point does not exceed the reference value, and when the second group includes a fourth plurality of vehicles exceeding a reference number, identifying a specific vehicle from among the fourth plurality of vehicles having the largest distance to the branch point, controlling the vehicles such that the specific vehicle maintains the platooning in the lane, and controlling the vehicles such that remaining vehicles to form a fourth sub-platoon in the another lane and subsequently merge at a tail of the platoon.

In an embodiment, a computer-readable medium may store one or more programs. The one or more programs, when executed by an electronic device for platooning of vehicles, may cause the electronic device to identify branch points for each of the vehicles on a route of the platooning, wherein the branch points are locations where the vehicles leave the platoon, identify distances from current positions of the vehicles to the branch points, determine an order of the vehicles in the platoon based on an ascending order of the identified distances, and based on determining that a lead vehicle in a current order of the vehicles in the platoon is different from a lead vehicle in the determined order and/or determining that a tail vehicle in the current order of the vehicles in the platoon is different from a tail vehicle in the determined order, control the vehicles such that the vehicles in the platoon are rearranged according to the determined order.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

In the above-described specific embodiments of the present disclosure, components included in the disclosure are expressed in the singular or plural according to the presented specific embodiment. However, the singular or plural expression is selected appropriately according to a situation presented for convenience of explanation, and the present disclosure is not limited to the singular or plural component, and even components expressed in the plural may be configured in the singular, or a component expressed in the singular may be configured in the plural.

According to various embodiments, one or more components or operations of the above-described components may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be executed sequentially, in parallel, repeatedly, or heuristically, or one or more of the operations may be executed in a different order or omitted, or one or more other operations may be added.

Meanwhile, specific embodiments have been described in the detailed description of the present disclosure, and of course, various modifications are possible without departing from the scope of the present disclosure.

What is claimed is:

1. An electronic device for platooning of vehicles, comprising:
memory storing instructions; and
a processor,
wherein the instructions, when executed by the processor, cause the electronic device to:
identify branch points for each of the vehicles on a route of the platooning, wherein the branch points are locations where the vehicles leave the platoon;
identify distances from current positions of the vehicles to the branch points;
determine an order of the vehicles in the platoon based on an ascending order of the identified distances; and
based on determining that a lead vehicle in a current order of the vehicles in the platoon is different from a lead vehicle in the determined order and/or determining that a tail vehicle in the current order of the vehicles in the platoon is different from a tail vehicle in the determined order, control the vehicles such that the vehicles in the platoon are rearranged according to the determined order.

2. The electronic device of claim 1,
wherein the instructions, when executed by the processor, cause the electronic device to:
based on identifying other vehicles from among the vehicles in which the distances to the branch points are less than a reference value, change the determined order such that the other vehicles are rearranged in the ascending order of the identified distances from the tail.

3. The electronic device of claim 2,
wherein the instructions, when executed by the processor, cause the electronic device to:
based on an insertion sort algorithm for the identified distances, identify at least one vehicle that has to leave the platoon to be rearranged according to the determined order;
determine the at least one vehicle as a first group, where a distance to the branch point exceeds the reference value, and/or as a second group, where a distance to the branch point does not exceed the reference value; and
control, when the first group includes a first plurality of vehicles, the vehicles such that the first plurality of vehicles form a first sub-platoon in another lane different from a lane in which the platoon is traveling and subsequently merge at a head of the platoon.

4. The electronic device of claim 3,
wherein the instructions, when executed by the processor, cause the electronic device to:
control, when the first group includes only one vehicle, the vehicles such that the one vehicle leaves the lane in which the platoon is traveling and subsequently merges at a head of the platoon.

5. The electronic device of claim 3,
wherein the instructions, when executed by the processor, cause the electronic device to:
control, when the second group includes a second plurality of vehicles, the vehicles such that the second plurality of vehicles form a second sub-platoon in the another lane from the lane in which the platoon is traveling and subsequently merge at a tail of the platoon.

6. The electronic device of claim 3,
wherein the instructions, when executed by the processor, cause the electronic device to:
control, when the second group includes only one other vehicle, the vehicles such that the one other vehicle leaves the lane in which the platoon is traveling and subsequently merges at a head of the platoon.

7. The electronic device of claim 3,
wherein the instructions, when executed by the processor, cause the electronic device to:
determine the at least one vehicle as the first group, where the distance to the branch point exceeds the reference value, and/or as the second group, where the distance to the branch point does not exceed the reference value; and
when the first group includes a third plurality of vehicles exceeding a reference number:
identify a specific vehicle from among the third plurality of vehicles having the largest distance to the branch point;
control the vehicles such that the specific vehicle maintains the platooning in the lane; and
control the vehicles such that remaining vehicles form a third sub-platoon in the another lane and subsequently merge at a head of the platoon.

8. The electronic device of claim 3,
wherein the instructions, when executed by the processor, cause the electronic device to:
determine the at least one vehicle as the first group, where a distance to the branch point exceeds the reference value, and/or as the second group, where a distance to the branch point does not exceed the reference value; and
when the second group includes a fourth plurality of vehicles exceeding a reference number:
identify a specific vehicle from among the fourth plurality of vehicles having the largest distance to the branch point;
control the vehicles such that the specific vehicle maintains the platooning in the lane; and
control the vehicles such that remaining vehicles to form a fourth sub-platoon in the another lane and subsequently merge at a tail of the platoon.

9. The electronic device of claim 1,
wherein the instructions, when executed by the processor, cause the electronic device to:
identify the closest vehicle to the branch point from among the vehicles;
confirm whether there is a section including multiple lanes in a route to the branch point of the closest vehicle;
based on confirming that there is no section including the multiple lanes in the route, determine a safe speed for the closest vehicle to leave the platoon at the branch point of the closest vehicle; and
control the vehicles such that the vehicles in the platoon travel at the safe speed until the closest vehicle leaves the platoon.

10. The electronic device of claim 1,
wherein the instructions, when executed by the processor, cause the electronic device to:
based on determining that a lead vehicle and a tail vehicle in the current order in the platoon are identical to a lead vehicle and a tail vehicle in the determined order, control the vehicles to maintain the current order of the vehicles.

11. The electronic device of claim 1,
wherein the instructions, when executed by the processor, cause the electronic device to:
obtain information regarding destinations of the vehicles from each of the vehicles; and
identify the branch points based on the information.

12. A method performed by an electronic device for platooning of vehicles, comprising:
identifying branch points for each of the vehicles on a route of the platooning, wherein the branch points are locations where the vehicles leave the platoon;
identifying distances from current positions of the vehicles to the branch points;
determining an order of the vehicles in the platoon based on an ascending order of the identified distances; and
based on determining that a lead vehicle in a current order of the vehicles in the platoon is different from a lead vehicle in the determined order and/or determining that a tail vehicle in the current order of the vehicles in the platoon is different from a tail vehicle in the determined order, controlling the vehicles such that the vehicles in the platoon are rearranged according to the determined order.

13. The method of claim 12, comprising:
based on identifying other vehicles from among the vehicles in which the distances to the branch points are less than a reference value, changing the determined order such that the other vehicles are rearranged in the ascending order of the identified distances from the tail.

14. The method of claim 13, comprising:
based on an insertion sort algorithm for the identified distances, identifying at least one vehicle that has to leave the platoon to be rearranged according to the determined order;
determining the at least one vehicle as a first group, where a distance to the branch point exceeds the reference value, and/or as a second group, where a distance to the branch point does not exceed the reference value; and
controlling, when the first group includes a first plurality of vehicles, the vehicles such that the first plurality of vehicles form a first sub-platoon in another lane different from a lane in which the platoon is traveling and subsequently merge at a head of the platoon.

15. The method of claim 14, comprising:
controlling, when the first group includes only one vehicle, the vehicles such that the one vehicle leaves the lane in which the platoon is traveling and subsequently merges at a head of the platoon.

16. The method of claim 15, comprising:
controlling, when the second group includes a second plurality of vehicles, the vehicles such that the second plurality of vehicles form a second sub-platoon in the another lane from the lane in which the platoon is traveling and subsequently merge at a tail of the platoon.

17. The method of claim 14, comprising:
controlling, when the second group includes only one other vehicle, the vehicles such that the one other vehicle leaves the lane in which the platoon is traveling and subsequently merges at a head of the platoon.

18. The method of claim 14, comprising:
determining the at least one vehicle as the first group, where the distance to the branch point exceeds the reference value, and/or as the second group, where the distance to the branch point does not exceed the reference value; and
when the first group includes a third plurality of vehicles exceeding a reference number:
identifying a specific vehicle from among the third plurality of vehicles having the largest distance to the branch point;
controlling the vehicles such that the specific vehicle maintains the platooning in the lane; and
controlling the vehicles such that remaining vehicles form a third sub-platoon in the another lane and subsequently merge at a head of the platoon.

19. The method of claim 14, comprising:
determining the at least one vehicle as the first group, where a distance to the branch point exceeds the reference value, and/or as the second group, where a distance to the branch point does not exceed the reference value; and
when the second group includes a fourth plurality of vehicles exceeding a reference number:
identifying a specific vehicle from among the fourth plurality of vehicles having the largest distance to the branch point;
controlling the vehicles such that the specific vehicle maintains the platooning in the lane; and
controlling the vehicles such that remaining vehicles to form a fourth sub-platoon in the another lane and subsequently merge at a tail of the platoon.

20. A computer-readable medium storing one or more programs, wherein the one or more programs, when executed by an electronic device for platooning of vehicles, cause the electronic device to:
identify branch points for each of the vehicles on a route of the platooning, wherein the branch points are locations where the vehicles leave the platoon;
identify distances from current positions of the vehicles to the branch points;
determine an order of the vehicles in the platoon based on an ascending order of the identified distances; and
based on determining that a lead vehicle in a current order of the vehicles in the platoon is different from a lead vehicle in the determined order and/or determining that a tail vehicle in the current order of the vehicles in the platoon is different from a tail vehicle in the determined order, control the vehicles such that the vehicles in the platoon are rearranged according to the determined order.
